(19) United States
(12) Patent Application Publication
(10) Pub. No.: US 2025/0012954 A1
(43) Pub. Date: Jan. 9, 2025

(54) HIGH EFFICIENCY OPTICAL COUPLER

(71) Applicant: Taiwan Semiconductor Manufacturing Company, Ltd., Hsinchu (TW)

(72) Inventors: Tai-Chun Huang, New Taipei City (TW); Chia-Ju Yu, Taichung City (TW); Stefan Rusu, Sunnyvale, CA (US)

(21) Appl. No.: 18/346,506

(22) Filed: Jul. 3, 2023

(51) Int. Cl. G02B 5/18; G02B 6/293

(52) U.S. Cl. CPC G02B 5/1823; G02B 5/1857; G02B 6/29302; G02B 6/29328

(57) ABSTRACT

Some embodiments relate to an optical module including a substrate; a first grating coupler overlying the substrate; and a second grating coupler overlying the first grating coupler, where the second grating coupler is configured to receive a first transverse mode of an input optical signal while passing a second transverse mode of the input optical signal to the first grating coupler, and where the first grating coupler is configured to receive the second transverse mode of the input optical signal.

### BACKGROUND

Optical couplers (such as grating couplers and edge couplers) are often used as components in photonic integrated circuits (PICs), which integrate multiple photonic functions. Optical couplers are used to confine and guide light from an optical fiber to an integrated chip with minimal attenuation. Grating couplers are more compact than edge couplers, and allow for a greater variation in coupling position. Edge couplers feature a higher coupling efficiency and broader bandwidth than grating couplers.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1B illustrate various views of some embodiments of an optical module with a second grating coupler overlying a first grating coupler according to the present disclosure.

FIGS. 2A-2E illustrate cross-sectional views of some alternative embodiments of the optical module of FIG. 1A with a first plurality of grating couplers and a second plurality of grating couplers.

FIGS. 3A-3L illustrate cross-sectional view of some alternative embodiments of the optical module.

FIGS. 4A-4B illustrate cross-sectional views of an optical module with extended grating lines.

FIG. 5 illustrates a top-down view of an optical module overlaid with the optical fields emerging from a fiber optic waveguide.

FIGS. 6A-6B. 7A-7B, 8A-8B, 9A-9B, 10A-10B, 11A-11B, 12A-12B, 13A-13B, 14A-14D, and 15A-15B illustrate cross-sectional views of some embodiments of a method of forming an optical module with a plurality of grating couplers and an optical combiner.

FIGS. 16A-16B, 17A-17B, 18A-18B, and 19A-19B, illustrate cross-sectional views of some embodiments of a continuation of the method described in conjunction with FIGS. 6A-6B, 7A-7B, 8A-8B, 9A-9B, 10A-10B. 11A-11B, 12A-12B, 13A-13B, 14A-14D, and 15A-15B to form a second plurality of grating couplers.

FIG. 20 illustrates a flow diagram of some embodiments of a method for forming an optical module with a plurality of grating couplers and an optical combiner.

### DETAILED DESCRIPTION

The present disclosure provides many different embodiments, or examples, for implementing different features of this disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Photonic integrated circuits (PICs) utilize optical signals (e.g., electromagnetic waves) to provide high speed signal communication. The use of optical signals provides lower power consumption and generates less heat compared to electrical signals. PICs receive the optical signals through optical modules such as grating couplers and edge couplers. Edge couplers have a higher coupling efficiency and broader bandwidth than grating couplers, though they are most effective when placed at the edge of a chip and take up a larger amount of space than grating couplers. Grating couplers have a more compact design and may be placed in more locations on the chip compared to edge couplers, but typically have a lower coupling efficiency, low alignment tolerance, and lower bandwidth than edge couplers.

For example, grating couplers may be polarization sensitive and may be configured to efficiently receive either a transverse electric (TE) mode (e.g., an electric field component) or a transverse magnetic (TM) mode (e.g., a magnetic field component) of an input optical signal, while not receiving the other. This may result in a lower coupling efficiency due to the energy lost from the unreceived mode. Grating couplers also have a low alignment tolerance, as the alignment of the fiber used to transport the input optical signal may rotate the input optical signal, thereby shifting a center wavelength of the input optical signal. Further, a narrow bandwidth of the grating coupler combined with the shift in the center wavelength may result in the input optical signal being unaligned with a peak of the bandwidth, thereby lowering the coupling efficiency. An optical module with a higher alignment tolerance, higher bandwidth, and higher coupling efficiency without the placement constraints and footprint of an edge coupler is desirable.

The present disclosure provides an optical module comprises a first grating coupler and a second grating coupler overlying the first grating coupler. The first grating coupler is configured to receive a first transverse mode (e.g., a TE mode) of input optical signals, while the second grating coupler are configured to receive a second transverse mode (e.g., TM mode) of input optical signals. This combination of grating couplers results in a greater coupling efficiency between the PIC and the fiber, as both TE and TM mode signals may be captured by the optical module.

In some embodiments, a first plurality of grating couplers and a second plurality of grating couplers including two or more grating couplers replace the first grating coupler and the second grating coupler to improve alignment tolerance, coupling efficiency, and bandwidth. By lining up the first plurality of grating couplers with bandwidths that partially overlap and coupling the grating couplers to an optical combiner, a bandwidth of the optical module may be increased. The grating couplers of the optical module are configured to receive an input optical signal from a single fiber due to their proximity to one another, and a variance in bandwidth across the grating couplers results in increased bandwidth compared to another optical module having a single grating coupler. Further, the bandwidth of the optical module maintains a loss of 1 dB or less across an increased bandwidth. The increased bandwidth of the optical module facilitates efficiently receiving input optical signals with a wider range of center wavelengths, thereby improving the alignment tolerance of the optical module.

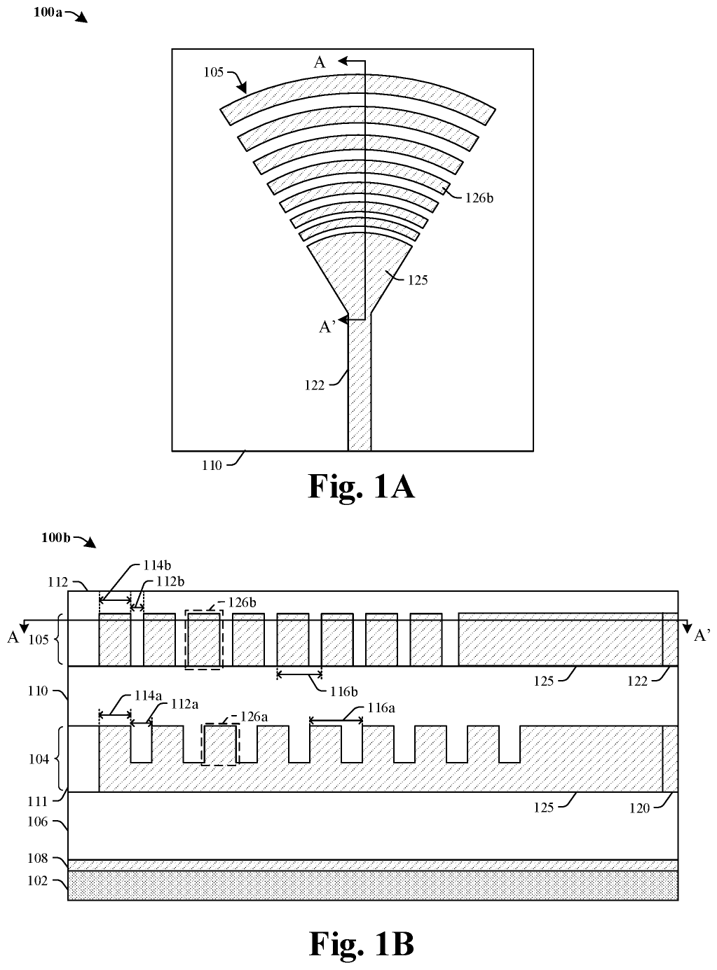

FIGS. 1A-1B illustrate various views of some embodiments of an optical module with a second grating coupler overlying a first grating coupler according to the present disclosure. FIG. 1A illustrates a top view 100a of some embodiments of the optical module. FIG. 1B illustrates a cross-sectional view 100b of some embodiments of the optical module taken along line A-A′ of FIG. 1A. FIGS. 1A-1B are described concurrently.

The optical module includes a first grating coupler 104 over a substrate 102. A second grating coupler 105 overlies the first grating coupler 104. The first grating coupler 104, and the second grating coupler 105 comprise first grating lines 126a and second grating lines 126b that are curved to guide input optical signals towards the first waveguide 120 and the second waveguide 122 respectively. In various embodiments, the first grating lines 126a and the second grating lines 126b of the first grating coupler 104 and the second grating coupler 105 may be straight (not shown).

The first grating coupler 104 and the second grating coupler 105 respectively comprise a tapered segment 125 laterally adjacent to corresponding grating lines 126. In various embodiments, a width of the tapered segment 125 continuously decreases when viewed in top view from the grating lines 126 towards the first and second waveguides 120, 122.

The first grating coupler 104 is separated from the substrate 102 by a first dielectric 106 and a mirror 108. The mirror 108 is configured to reflect optical signals that pass through the grating coupler back towards the grating coupler to increase the coupling efficiency. A second dielectric 111 surrounds outer sidewalls of the first grating coupler 104, and a third dielectric 110 overlies the first grating coupler 104. A fourth dielectric 112 overlies the second grating coupler 105. In some embodiments, the first dielectric 106, the second dielectric 111, the third dielectric 110, and the fourth dielectric 112 are or comprise a dielectric material, such as silicon dioxide (SiO₂), or the like.

The first grating coupler 104 comprises grating lines 126 with a first grating period 116a (e.g., the distance between the start of a first grating line and the start of a subsequent grating line), a first spacing 112a (e.g., the distance between the end of the first grating line and the start of the subsequent grating line), and a first duty cycle 114a (e.g., the proportion of the grating period that is occupied by the first grating line). In some embodiments, the first grating period 116a corresponds to a distance from an outer sidewall of a first grating line 126f to an outer sidewall of an adjacent grating line 126s. An effective refractive index of the first grating coupler 104 is based at least in part on the first duty cycle 114a and the first spacing 112a. A first center wavelength λ₁ of the first grating coupler 104 is based at least in part on the first grating period 116a and/or the effective refractive index of the first grating coupler 104. In various embodiments, the first grating coupler 104 has a first bandwidth that may, for example, be approximately 40 nanometers (nm) or some other value. In some embodiments, an upper wavelength limit of the first bandwidth is λ₁+x/2 (where x is the first bandwidth of the first grating coupler 104) and a lower wavelength limit of the first bandwidth is λ₁−x/2. In further embodiments, the first center wavelength λ₂ of the first grating coupler 104 is equal to a resonant wavelength of the first grating coupler 104. In yet further embodiments, the first center wavelength λ₁ may correspond to a center wavelength of the plurality of grating couplers 101.

The second grating coupler 105 has a second duty cycle 114b, a second spacing 112b, and a second grating period 116b. The second duty cycle 114b and the second spacing 112b configure the effective refractive index of the second grating coupler 105. In some embodiments, the fourth grating period 116d and/or the effective refractive index configures the center wavelength of the second grating coupler 105 such that the bandwidth of the second grating coupler 105 is approximately the same as the bandwidth of the first grating coupler 104. In various embodiments, the second duty cycle 114b and/or the second spacing 112b are different from those of the first grating coupler 104, such that the second grating coupler 105 has a different effective refractive index than that of the first grating coupler 104. In further embodiments, the second grating period 116b is different from the first grating period 116a to configure the center wavelength of the second grating coupler 105.

In some embodiments, the first grating coupler 104, is configured to receive a first transverse mode (e.g., one of TE mode or TM mode) of optical signals. The second grating coupler 105 is configured to receive a second transverse mode (e.g., TM mode if the first mode is TE mode, or TE mode if the first mode is TM mode) of optical signals. For example, when an unpolarized input signal is provided to the optical module at a first angle, the first grating coupler 104 is configured to receive first transverse mode portions of the unpolarized input signal and the second grating coupler 105 is configured to receive second transverse mode portions of the unpolarized input signal. This configuration results in an optical module that can couple to multiple modes while maintaining the flexibility of placement inherent to grating couplers.

Effective refractive indexes that affect receival of TE mode signals and TM mode signals are different in grating couplers. For example, a grating coupler may have a first effective refractive index that alters the receiving of TE mode signals and a second effective refractive index that alters the receiving of TM mode signals. The effective refractive indexes are based at least in part on the spacing of the grating lines of the grating coupler. The period of the grating lines (e.g., the distance between the start of a first grating line and the start of a subsequent grating line) combined with the effective refractive index may define the center wavelength of the bandwidth of a grating coupler. Therefore, the first grating period 116a of the first grating coupler 104 is configured to receive optical signals of the first mode at different frequencies proximate to the center wavelength of the first grating coupler 104. The second grating period 116b of the second grating coupler 105 is configured to receive optical signals of the second mode at different frequencies proximate to the center wavelength of the second grating coupler 105.

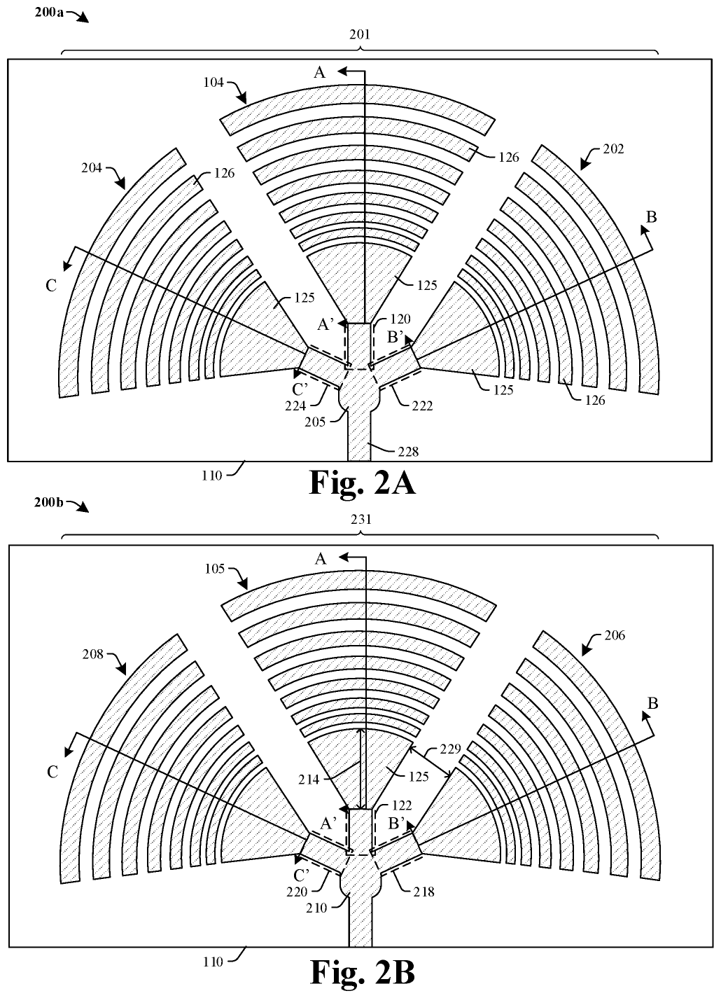

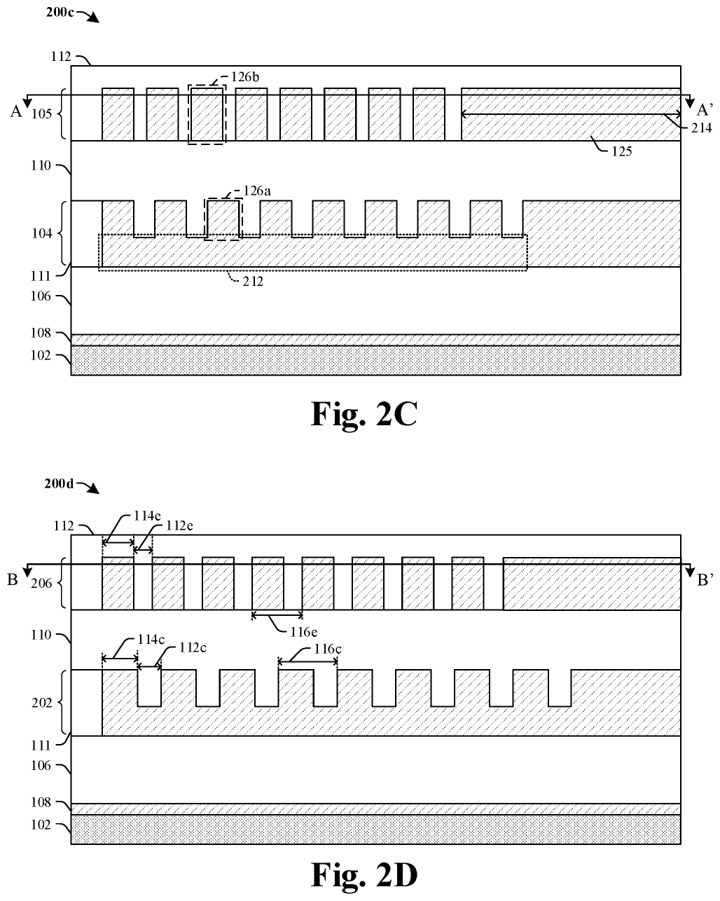

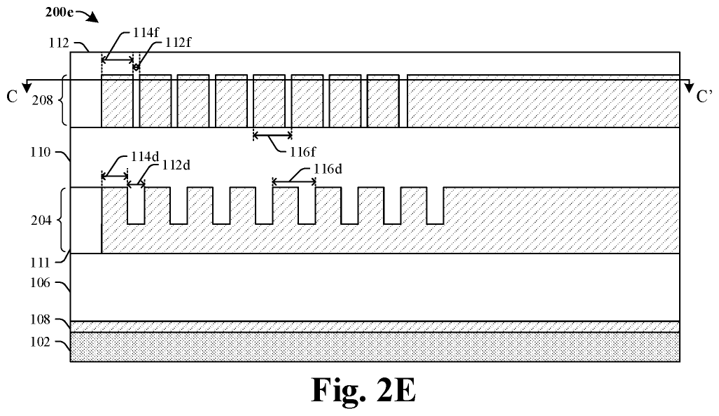

FIGS. 2A-2E illustrate cross-sectional views of some alternative embodiments of the optical module of FIG. 1A with a first plurality of grating couplers and a second plurality of grating couplers. FIG. 2A illustrates a top view 200a of some embodiments of the optical module taken level with the first plurality of grating couplers. FIG. 2B illustrates a top view 200b of some embodiments of the optical module taken level with the second plurality of grating couplers. FIG. 2C illustrates a cross-sectional view 200c of some embodiments of the optical module taken along line A-A′ of FIGS. 2A and 2B. FIG. 2D illustrates a cross-sectional view 200d of some embodiments of the optical module taken along line B-B′ of FIGS. 2A and 2B. FIG. 2E illustrates a cross-sectional view 200e of some embodiments of the optical module taken along line C-C′ of FIGS. 2A and 2B.

In some embodiments, the optical module includes a first plurality of grating couplers 201. The first plurality of grating couplers 201 comprises the first grating coupler 104, a third grating coupler 202 and a fourth grating coupler 204 proximate to one another. The first grating coupler 104, the third grating coupler 202, and the fourth grating coupler 204 are coupled to an optical combiner 205 by the first waveguide 120, a third waveguide 222, and a fourth waveguide 224, respectively. The first grating coupler 104, the third grating coupler 202, and the fourth grating coupler 204 comprise grating lines 126 that are curved to guide input optical signals towards the first waveguide 120, the third waveguide 222, and the fourth waveguide 224 respectively.

The first waveguide 120 branches off of the optical combiner 205 in a first direction towards the first grating coupler 104 and optically couples the first grating coupler 104 to the optical combiner 205. The third waveguide 222 branches off of the optical combiner 205 in a second direction towards the third grating coupler 202 and optically couples the third grating coupler 202 to the optical combiner 205. The fourth waveguide 224 branches off of the optical combiner 205 in third direction towards the fourth grating coupler 204 and optically couples the fourth grating coupler 204 to the optical combiner 205. In various embodiments, the first direction, the second direction, and the third direction are different from one another. The first grating coupler 104, the third grating coupler 202, and the fourth grating coupler 204 are configured to each receive an individual input optical signal and/or are configured to receive different portions of an input optical signal. Optical signals input into the first grating coupler 104, the third grating coupler 202, and the fourth grating coupler 204 are carried to the optical combiner 205 by way of the first waveguide 120, the third waveguide 222, and the fourth waveguide 224. The optical combiner 205 is configured to combine the optical signals into a combined optical signal that is passed to an input/output (I/O) waveguide 228.

As shown in FIG. 2B, in some embodiments, a second plurality of grating couplers 231 overly the first plurality of grating couplers 201 (see FIG. 2A). The second plurality of grating couplers 231 comprises the second grating coupler 105, a fifth grating coupler 206, and a sixth grating coupler 208. The second grating coupler 105, the fifth grating coupler 206, and the sixth grating coupler 208 are coupled to a second optical combiner 210 by the second waveguide 122, a fifth waveguide 218, and a sixth waveguide 220, respectively. The fourth dielectric 112 covers the second plurality of grating couplers 231.

In some embodiments, the length 214 of a tapered segment 125 of the second grating coupler 105 is approximately between 20 and 50 micrometers, approximately between 15 and 40 micrometers, approximately between 25 and 60 micrometers, or the like. The tapered segment 125 may be between 30 and 70% of the length 214 of the second grating coupler 105. The first, third, fourth, fifth, and sixth grating coupler 104, 202, 204, 206, 208 also have tapered segments 125 with lengths within the same range of values as the length 214. In some embodiments, a distance 229 between the second grating coupler 105 and the fifth grating coupler 206 is less than a length of the second grating coupler 105.

As shown in FIG. 2C, in some embodiments, the first plurality of grating couplers (see 201 of FIG. 2A) comprise the first grating lines 126a that extend from a grating base 212 when viewed from a cross-sectional view. A height of the first grating lines 126a is approximately twenty to eighty percent of the thickness of the first grating coupler 104. In some embodiments, the second plurality of grating couplers 231 have second grating lines 126b that are physically isolated from one another. That is, when forming the second plurality of grating couplers 231, a second waveguide precursor was etched completely through and a dielectric material completely surrounds the second grating lines 126b when viewed from a cross-sectional view. In some embodiments, a distance between the first grating coupler 104 and the second grating coupler 105 is less than a length of the first grating coupler 104.

As shown in FIG. 2D, the third grating coupler 202 comprises grating lines 126 with a third duty cycle 114c, a third spacing 112c, and a third grating period 116c. An effective refractive index of the third grating coupler 202 is based at least in part on the third duty cycle 114c and the third spacing 112c. A second center wavelength λ₂ of the third grating coupler 202 is based at least in part on the third grating period 116c and/or the effective refractive index of the third grating coupler 202. In various embodiments, the effective refractive index of the third grating coupler 202 and/or the third grating period 116c are different from that of the first grating coupler 104, such that a range of a second bandwidth of the third grating coupler 202 at least partially overlaps or is proximate to a first outer wavelength limit (e.g., the upper wavelength limit of the first bandwidth) of the first bandwidth of the first grating coupler 104. For example, the second center wavelength λ₂ may be equal to λ₁+x (where x is the first bandwidth of the first grating coupler 104). In various embodiments, an upper wavelength limit of the second bandwidth may be approximately λ₂+x/2 and a lower wavelength limit of the second bandwidth may be approximately λ₂−x/2. In further embodiments, the second center wavelength λ₂ of the third grating coupler 202 is equal to a resonant wavelength of the third grating coupler 202.

A fifth duty cycle 114e and/or a fifth spacing 112e of the fifth grating coupler 206 configure the effective refractive index of the fifth grating coupler 206. A fifth grating period 116e and/or the effective refractive index configures the center wavelength of the fifth grating coupler 206 such that the bandwidth of the fifth grating coupler 206 matches the bandwidth of the second grating coupler 105. Therefore, for the bandwidth of the fifth grating coupler 206 to be different from the bandwidth of the second grating coupler 105, the fifth grating period 116e and/or the effective refractive index of the fifth grating coupler 206 are different from the second grating period 116b and/or the effective refractive index of the second grating coupler 105.

As shown in FIG. 2E, the fourth grating coupler 204 comprises grating lines 126 with a fourth duty cycle 114d, a fourth spacing 112d, and a fourth grating period 116d. An effective refractive index of the fourth grating coupler 204 is based at least in part on the fourth duty cycle 114d and the fourth spacing 112d. A third center wavelength λ₃ of the fourth grating coupler 204 is based at least in part on the fourth grating period 116d and/or the effective refractive index of the fourth grating coupler 204. In various embodiments, the effective refractive index of the fourth grating coupler 204 and/or the fourth grating period 116d are different from that of the first grating coupler 104, such that a range of a third bandwidth of the fourth grating coupler 204 at least partially overlaps or is proximate to a second outer wavelength limit (e.g., the lower wavelength limit of the first bandwidth) of the first bandwidth of the first grating coupler 104. For example, the third center wavelength λ₃ may be equal to λ₁−x (where x is the first bandwidth of the first grating coupler 104). In various embodiments, an upper wavelength limit of the third bandwidth is λ₃+x/2 and a lower wavelength limit of the third bandwidth is λ₃−x/2. In further embodiments, the third center wavelength λ₃ of the fourth grating coupler 204 is equal to a resonant wavelength of the fourth grating coupler 204. In various embodiments, an effective overall bandwidth of the first plurality of grating couplers 201 is equal to a sum of the bandwidths of the first, third, and fourth grating couplers 104, 202, 204. Accordingly, the bandwidths of the first plurality of grating couplers 201, combined with the proximity of the first plurality of grating couplers 201 to one another and coupling to the optical combiner 205, result in an optical module that may transfer an input optical signal from a fiber with an overall bandwidth up to two to four times greater than an individual grating coupler (e.g., greater than the first bandwidth of the first grating coupler 104). As a result, a coupling efficiency and an overall performance of the optical module is increased.

A sixth duty cycle 114f and a sixth spacing 112f of the sixth grating coupler 208 configure the effective refractive index of the sixth grating coupler 208. A sixth grating period 116f configures the center wavelength of the sixth grating coupler 208 such that the bandwidth of the sixth grating coupler 208 matches the bandwidth of the fourth grating coupler 204. Therefore, for the bandwidth of the sixth grating coupler 208 to be different from the bandwidth of the second grating coupler 105, the sixth grating period 116f and/or the effective refractive index of the sixth grating coupler 208 are different from the second grating period 116b and/or the effective refractive index of the second grating coupler 105.

In some embodiments, the first grating coupler 104, the third grating coupler 202, and the fourth grating coupler 204 are configured to receive a first transverse mode (e.g., one of TE mode or TM mode) of optical signals. The second grating coupler 105, the fifth grating coupler 206, and the sixth grating coupler 208 are configured to receive a second transverse mode (e.g., TM mode if the first mode is TE mode, or TE mode if the first mode is TM mode) of optical signals. For example, when an unpolarized input signal is provided to the optical module at a first angle, the first plurality of grating couplers 201 (see FIG. 2A) is configured to receive first transverse mode portions of the unpolarized input signal and the second plurality of grating couplers 231 is configured to receive second transverse mode portions of the unpolarized input signal. This configuration results in an optical module that can couple to multiple modes while maintaining the flexibility of placement inherent to grating couplers.

Effective refractive indexes that affect receival of TE mode signals and TM mode signals are different in grating couplers. For example, a grating coupler may have a first effective refractive index that alters the receiving of TE mode signals and a second effective refractive index that alters the receiving of TM mode signals. The effective refractive indexes are based at least in part on the spacing of the grating lines of the grating coupler. The period of the grating lines (e.g., the distance between the start of a first grating line and the start of a subsequent grating line) combined with the effective refractive index may define the center wavelength of the bandwidth of a grating coupler.

Therefore, the first grating period 116a, the third grating period 116c, and the fourth grating period 116d of the first grating coupler 104, the third grating coupler 202, and the fourth grating coupler 204 respectively, are configured to receive optical signals of the first mode at different frequencies proximate to the center wavelength of the first grating coupler 104. The second grating period 116b, the fifth grating period 116e, and the sixth grating period 116f of the second grating coupler 105, the fifth grating coupler 206, and the sixth grating coupler 208 respectively, are configured to receive optical signals of the second mode at different frequencies proximate to the center wavelength of the second grating coupler 105.

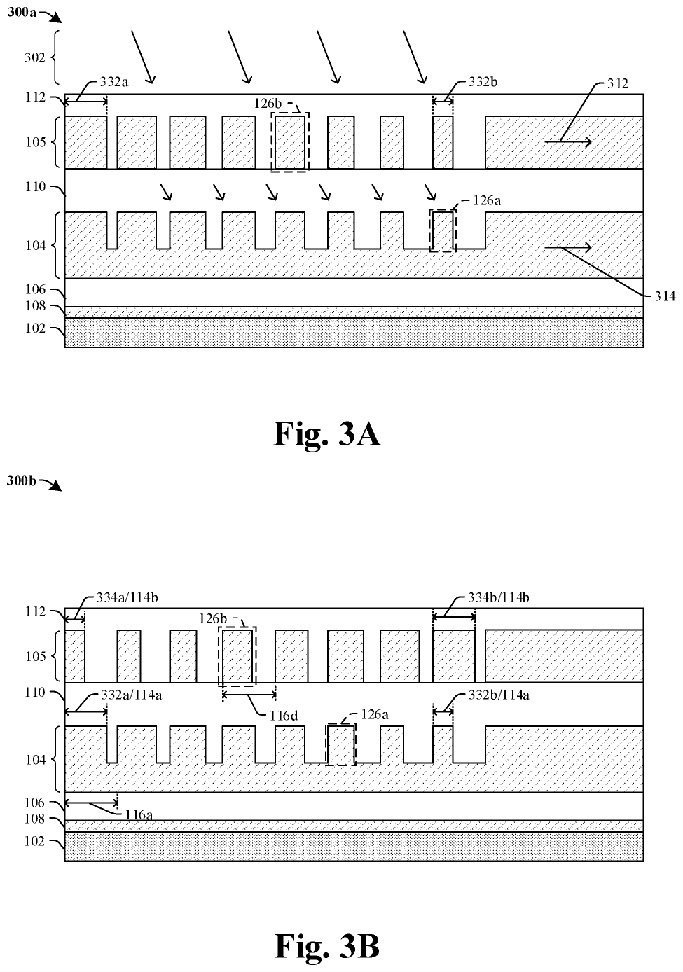

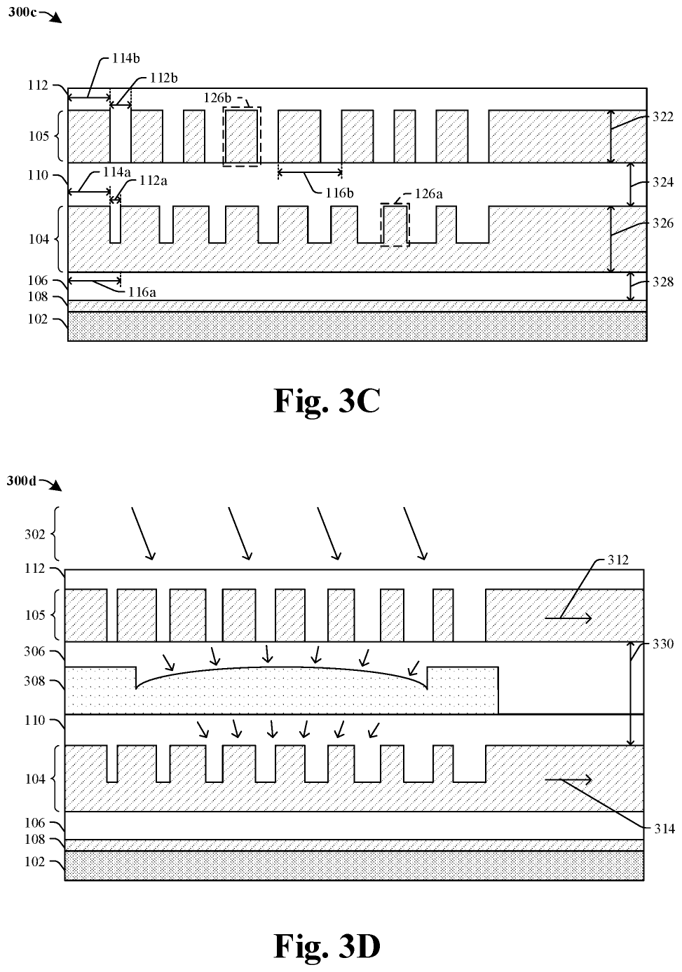

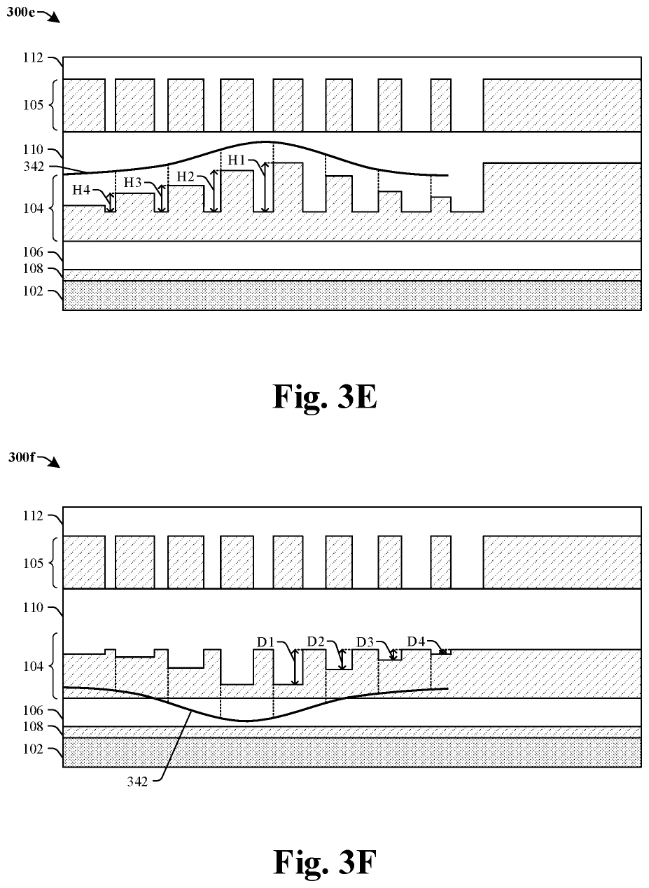

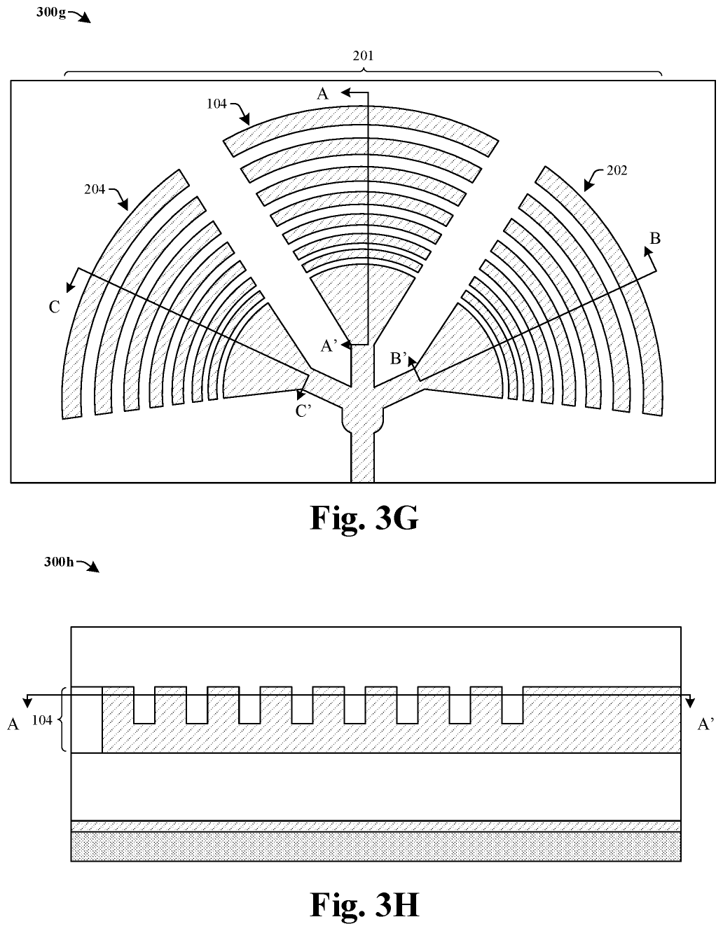

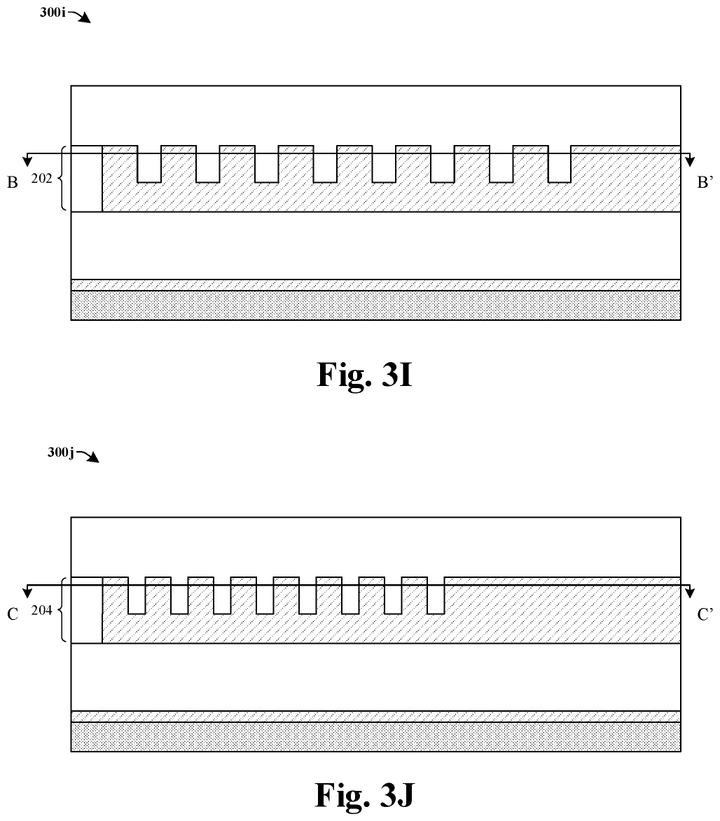

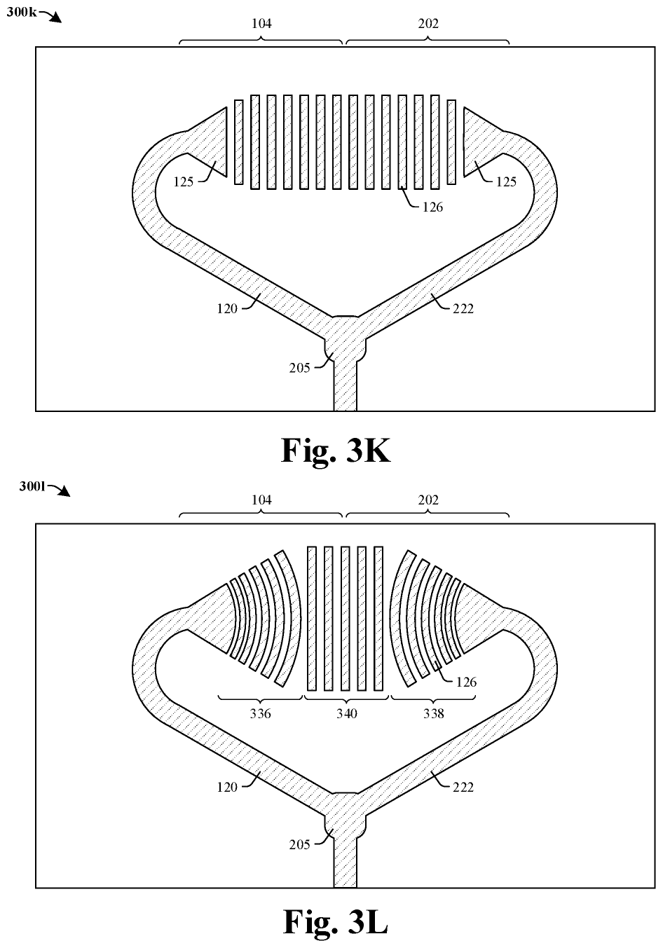

FIGS. 3A-3L illustrate cross-sectional views 300a-3001 of some alternative embodiments of the optical module.

As shown in the cross-sectional view 300a of FIG. 3A, the electromagnetic input signal 302 is directed toward the first grating coupler 104 and the second grating coupler 105. In some embodiments, a first mode portion 312 of the electromagnetic input signal 302 is coupled to the second grating coupler 105, and a second mode portion 314 of the electromagnetic input signal 302 passes through the second grating coupler 105 to the first grating coupler 104. Portions of the electromagnetic input signal 302 may also couple to the second, third, fifth, and sixth grating couplers (see 202, 204, 206, 208 of FIGS. 2A, 2B).

In some embodiments, the first plurality of grating couplers 201 (see FIG. 2A) and the second plurality of grating couplers 231 (see FIG. 2B) may be apodized (e.g., having first and second grating lines 126a, 126b with a varying duty cycle or period). Apodized grating couplers may have a higher coupling efficiency than grating couplers with a uniform duty cycle. For example, as shown in FIG. 3A, the outermost duty cycle 332a of the first grating lines 126a may be higher than the innermost duty cycle 332b of innermost grating lines. As shown in in the cross-sectional view 300b of FIG. 3B, the outermost duty cycle 332a of the first grating coupler 104 may be larger than the innermost duty cycle 332b, while the outermost duty cycle 334a of the second grating coupler 105 may be smaller than the innermost duty cycle 334b. The first and second duty cycles 114a, 114b or the first and second grating periods 116a, 116b may follow a linear scale, and exponential scale, a gaussian distribution, or the like. In some embodiments, as shown in the cross-sectional view 300c of FIG. 3C, the second duty cycle 114b and second grating period 116b of the second grating coupler 105 may increase and decrease throughout the second grating coupler 105 at various intervals. For example, the second grating period 116b or the second duty cycle 114b may be greatest towards the center of the second grating coupler 105, while the second grating period 116b or the second duty cycle 114b may be smallest for the second grating lines 126b at the edges of the second grating coupler 105. The duty cycles and periods of the first, third, fourth, fifth, and sixth grating couplers 104, 202, 204, 206, 208, may also increase and decrease in a similar fashion to the second grating coupler 105.

As shown in the cross-sectional view 300c of FIG. 3C, in some embodiments, the second grating coupler 105 has a first thickness 322 approximately between 50 and 1000 nanometers, approximately between 40 and 800 nanometers, approximately between 60 and 1200 nanometers, or within another suitable range. The fifth grating coupler 206 and the sixth grating coupler 208 have a thickness equal to the first thickness 322. In some embodiments, the first grating coupler 104 has a second thickness 326 approximately between 50 and 1000 nanometers, approximately between 40 and 800 nanometers, approximately between 60 and 1200 nanometers, or within another suitable range. The third grating coupler 202 and the fourth grating coupler 204 have a thickness equal to the second thickness 326. In some embodiments, the third dielectric 110 has a third thickness 324 measured between a bottom surface of the second grating coupler 105 and a top surface of the first grating coupler 104 approximately between 0 and 6 micrometers, approximately between 1 and 8 micrometers, approximately between 0 and 4 micrometers, or within another suitable range. In some embodiments, the first dielectric 106 has a fourth thickness 328 approximately between 2 and 6 micrometers, approximately between 1 and 5 micrometers, approximately between 3 and 7 micrometers, or within another suitable range. In some embodiments, the third thickness between the first grating coupler 104 and the second grating coupler 105 is less than a length of the first grating coupler 104.

As shown in the cross-sectional view 300d of FIG. 3D, in some embodiments, a lens 308 (e.g., a micro lens) is between the first grating coupler 104 and the second grating coupler 105. The lens 308 is surrounded by a fifth dielectric 306. The lens 308 may direct the second mode portion 314 of the electromagnetic input signal 302 toward an optimal position in the first grating coupler 104, increasing the coupling efficiency. In some embodiments, the lens 308 comprises silicon dioxide (SiO₂), polysilicon, or the like. In some embodiments, when the lens 308 comprises silicon dioxide, the silicon dioxide of the lens 308 has a different crystalline structure than the silicon dioxide of the third dielectric 110 due to being formed under different temperature and pressure conditions. In some embodiments, the lens 308 has a radius of curvature approximately between 100 and 600 micrometers, approximately between 80 and 500 micrometers, approximately between 120 and 700 micrometers, or within another suitable range. In some embodiments, a fifth thickness 330 measured between a bottom surface of the second grating coupler 105 and a top surface of the first grating coupler 104 is approximately between 100 and 1000 micrometers, approximately between 80 and 800 micrometers, approximately between 120 and 1200 micrometers, or within another suitable range.

As shown in in the cross-sectional view 300e of FIG. 3E, the first plurality of grating couplers 201 (see FIG. 2A) including the first grating coupler 104 may have apodized grating line heights H1, H2, H3, H4 (e.g., the grating lines have heights that vary across the grating coupler). For example, grating lines near the center of a plurality of grating lines may have a first height H1, while the surrounding grating lines may successively have a second height H2 less than the first height H1, a third height H3 less than the second height H2, and a fourth height H4 less than the third height H3. In some embodiments, the apodized grating line heights H1, H2, H3, H4 may have a Gaussian distribution 342. In other embodiments, the heights of the grating lines may be arranged in a different pattern. The apodized grating line heights may increase the coupling efficiency of the first grating coupler 104 further, and may be used in conjunction with the apodization of the duty cycle or period as discussed with FIGS. 3A-3C. The third grating coupler (see 202 of FIG. 2A) and the fourth grating coupler (see 204 of FIG. 2A) may additionally have apodized grating line heights.

As shown in the cross-sectional view 300f of FIG. 3F, in some embodiments, instead of having apodized grating line heights, the first plurality of grating couplers 201 (see FIG. 2A) may have apodized etching depths D1, D2, D3, D4. The apodized etching depths D1, D2, D3, D4 may increase the coupling efficiency of the first plurality of grating couplers. In some embodiments, the apodized etching depths D1, D2, D3, D4 may have a gaussian distribution 342. In other embodiments, the apodized etching depths D1, D2, D3, D4 of the grating lines may be arranged in a different pattern. The third grating coupler (see 202 of FIG. 2A) and the fourth grating coupler (see 204 of FIG. 2A) may additionally have apodized etching depths.

The cross-sectional views 300g. 300h, 300i, 300j, of FIGS. 3G, 3H, 3I, and 3J are described concurrently. In some embodiments, the second plurality of grating couplers (see 231 of FIG. 2B) are omitted, while the first plurality of grating couplers 201 (e.g., the first, third, and fourth grating couplers 104, 202, 204) is maintained. The resulting optical module is configured to receive either TE or TM modes of the electromagnetic input signal 302 (see FIG. 3A) with an increased bandwidth and greater alignment tolerance while having a shorter vertical structure (e.g., the space the optical module occupies in the device). The optical module therefore has an increased bandwidth and greater alignment tolerance than the first grating coupler 104 alone would have, while having the same number of steps to form as a conventional grating coupler.

As shown in the cross-sectional views 300k, 3001 of FIGS. 3K and 3L, in some embodiments, the fourth and sixth grating couplers (see 204, 208 of FIG. 2D) are omitted. Further, the first and third grating couplers 104, 202 are facing away from one another. That is, the grating lines 126 of the first grating coupler 104 and the third grating coupler 202 are directly between the tapered segment 125 of the first grating coupler 104 and the tapered segment 125 of the third grating coupler 202. In further embodiments, the second grating coupler (see 105 of FIG. 2A) and the fifth grating coupler (see 206 of FIG. 2A) are facing away from one another and overlying the first grating coupler 104 and the third grating coupler 202. The first waveguide 120 and the third waveguide 222 are curved to direct the input optical signals towards the optical combiner 205. In FIG. 3I, the grating lines 126 are substantially straight. In FIG. 3J, a first portion 336 and a second portion 338 of the grating lines 126 are respectively curved towards the tapered segment 125 of the first grating coupler 104 and the tapered segment 125 of the third grating coupler 202. A third portion 340 of the grating lines 126 are substantially straight and are between the first portion 336 and the second portion 338.

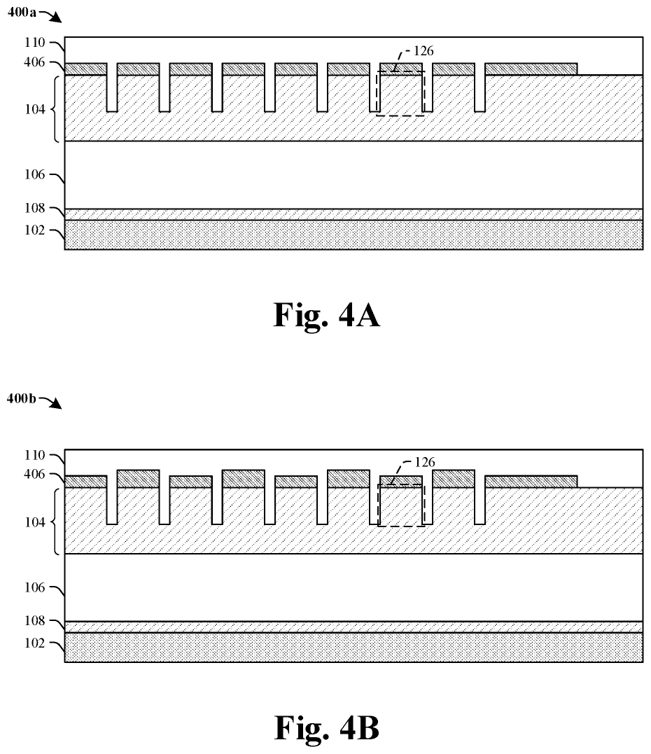

FIGS. 4A and 4B illustrate cross-sectional views 400a, 400b of an optical module with extended grating lines.

As shown in FIG. 4A, a polysilicon layer 406 may be included on top of the first plurality of grating couplers 201 (see FIG. 2A), the second plurality of grating couplers 231 (see FIG. 2B), or both. The polysilicon layer 406 may extend the height of the grating lines 126, altering the coupling properties. As shown in FIG. 4B, in some embodiments the polysilicon layer 406 has heights that vary across the grating lines 126. The polysilicon layer 406 may be combined with the apodization shown in FIGS. 3A-3C and 3E-3F to control the coupling efficiency of the optical module.

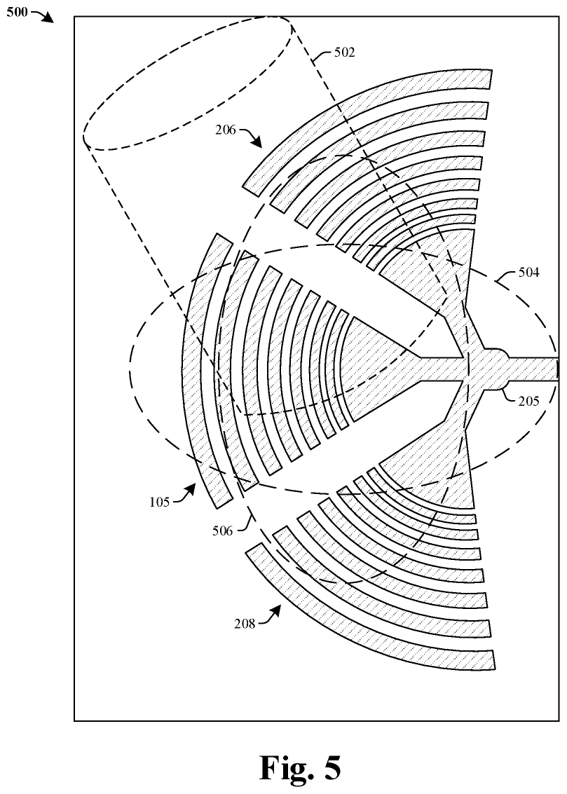

FIG. 5 illustrates a top-down view 500 of an optical module overlaid with the optical fields emerging from a fiber optic cable.

As shown in FIG. 5, a fiber optic cable 502 (shown in phantom) impinges on the optical module. The energy transmitted by the fiber optic cable 502 is output into two optical fields: a first mode optical field 504 and a second mode optical field 506. The first mode optical field 504 and the second mode optical field 506 correspond to the optical field made by the first mode portion 312 (see FIG. 3A) and the second mode portion 314 (see FIG. 3A) respectively. A change in the incident angle (e.g., the amount that the fiber optic cable 502 is rotated) may cause a shift in the center wavelength of the electromagnetic input signal 302 coupled to the optical module. In some embodiments, a change in the incident angle may change the center wavelength of the electromagnetic input signal by approximately two nanometers per degree. A change in the incident angle will also rotate the first mode optical field 504 and the second mode optical field 506.

Conventional grating couplers may have a bandwidth of approximately 20 to 40 nanometers. The optical device described has an increased 1 dB bandwidth resulting from the combination of the bandwidths of the second grating coupler 105, the fifth grating coupler 206, and the sixth grating coupler 208, in addition to the first plurality of grating couplers (See FIG. 1A). The increased 1 dB bandwidth may be two to four times the 1 dB bandwidth of a conventional grating coupler. The increased 1 dB bandwidth of the optical module results in a higher alignment tolerance, as the coupling efficiency is maintained over a higher range of incident angles.

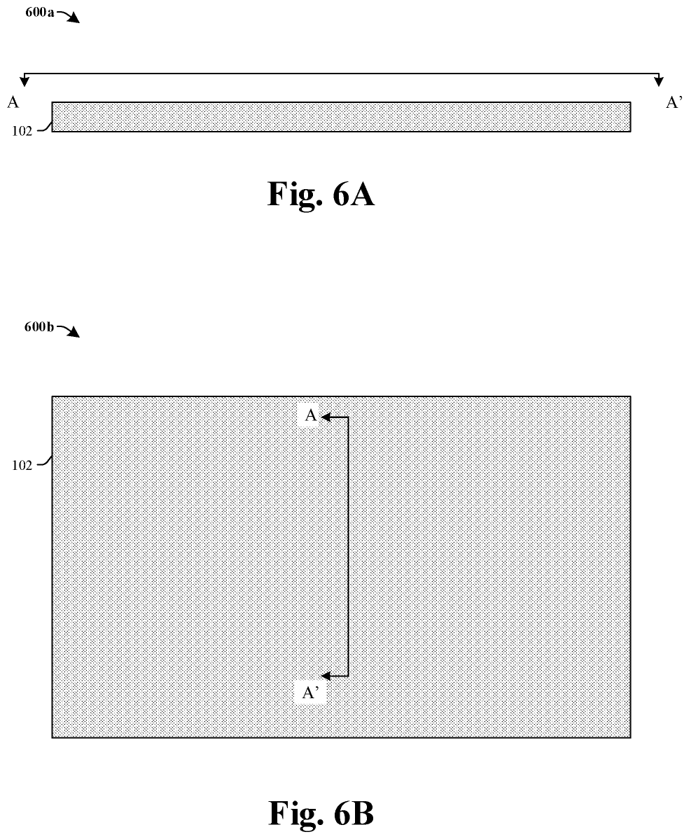

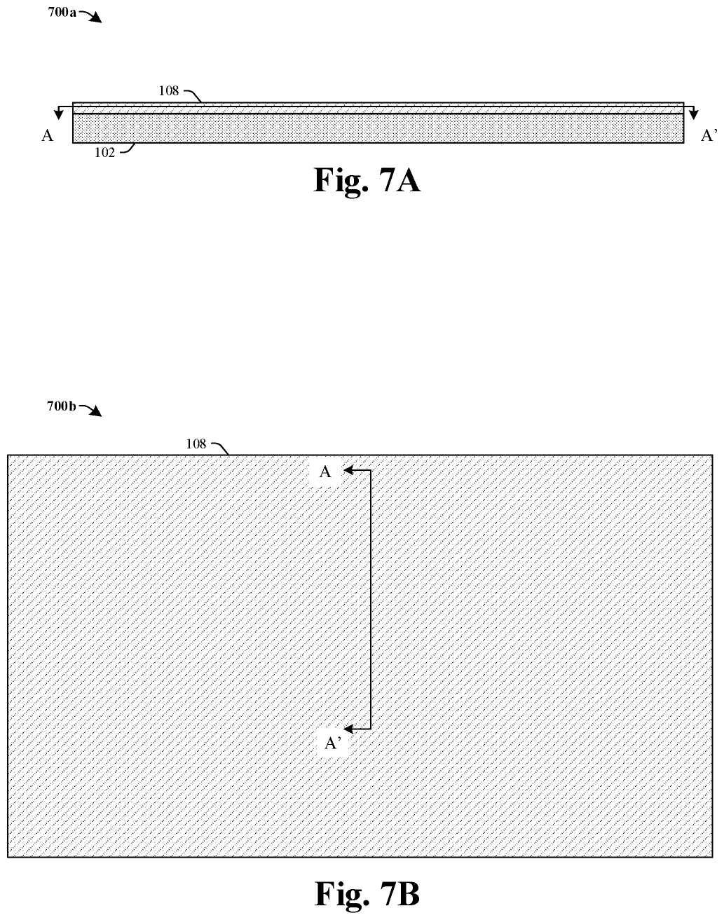

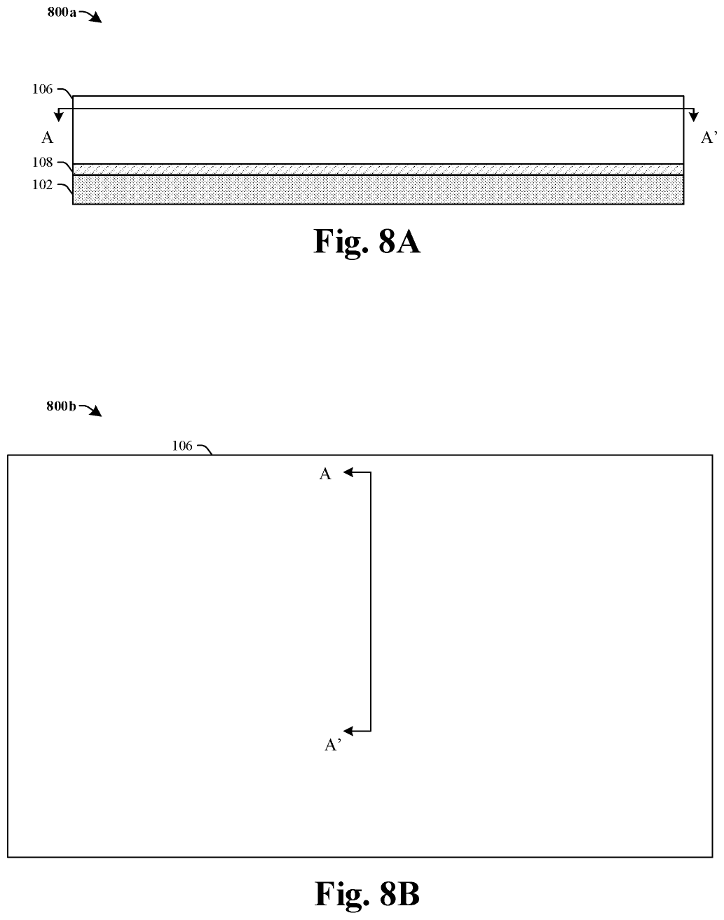

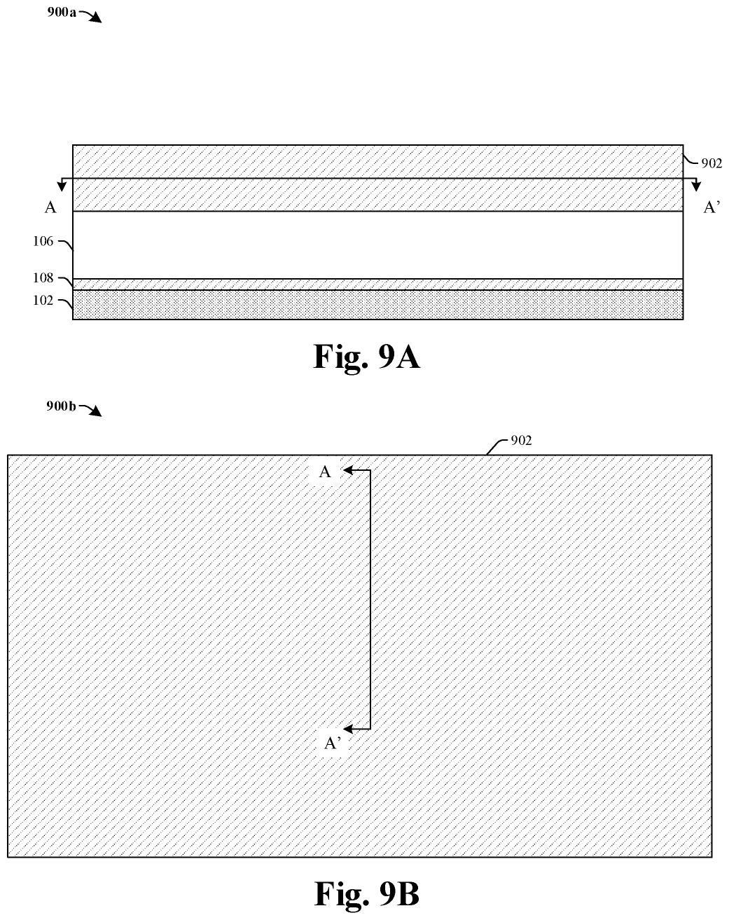

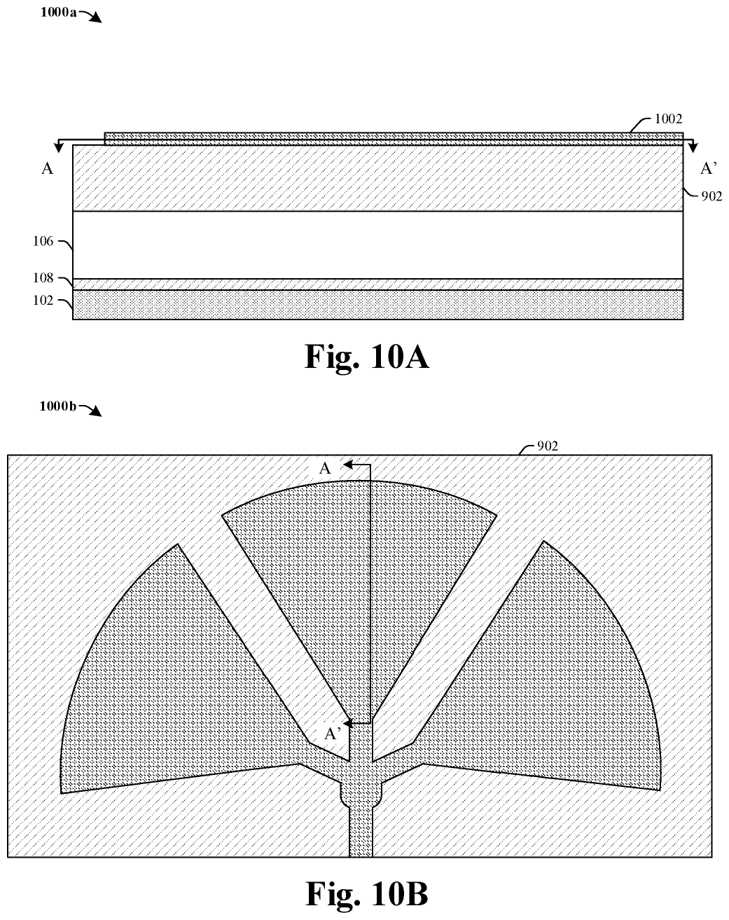

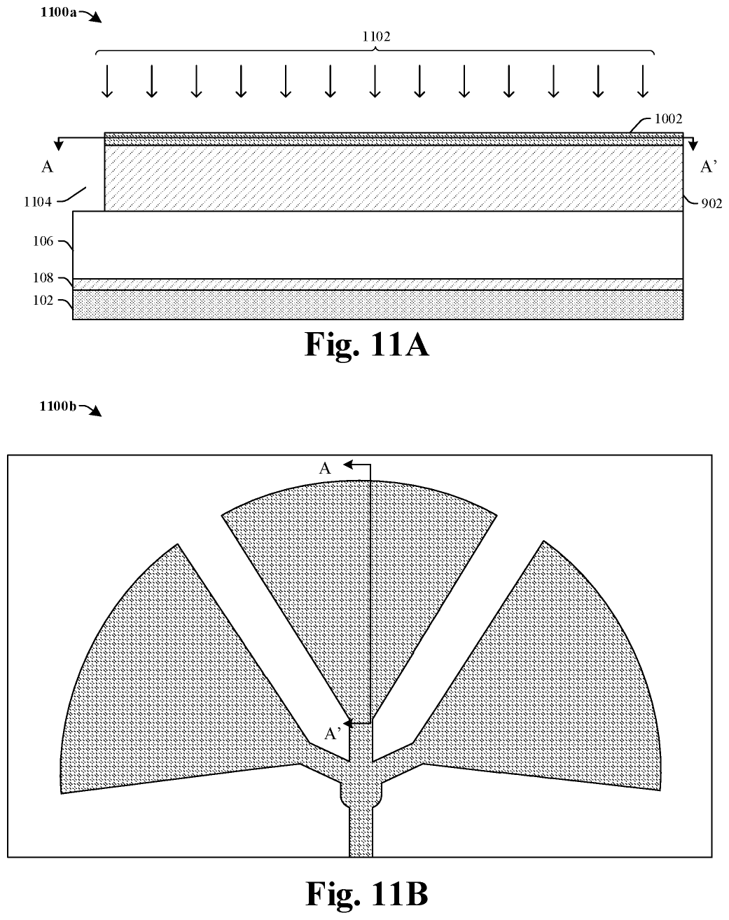

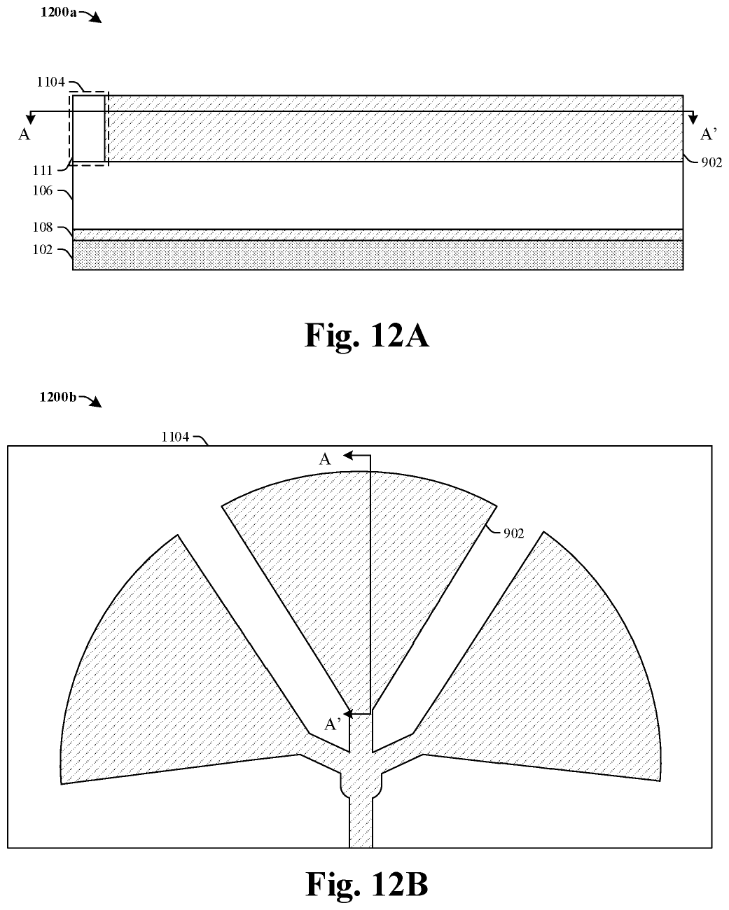

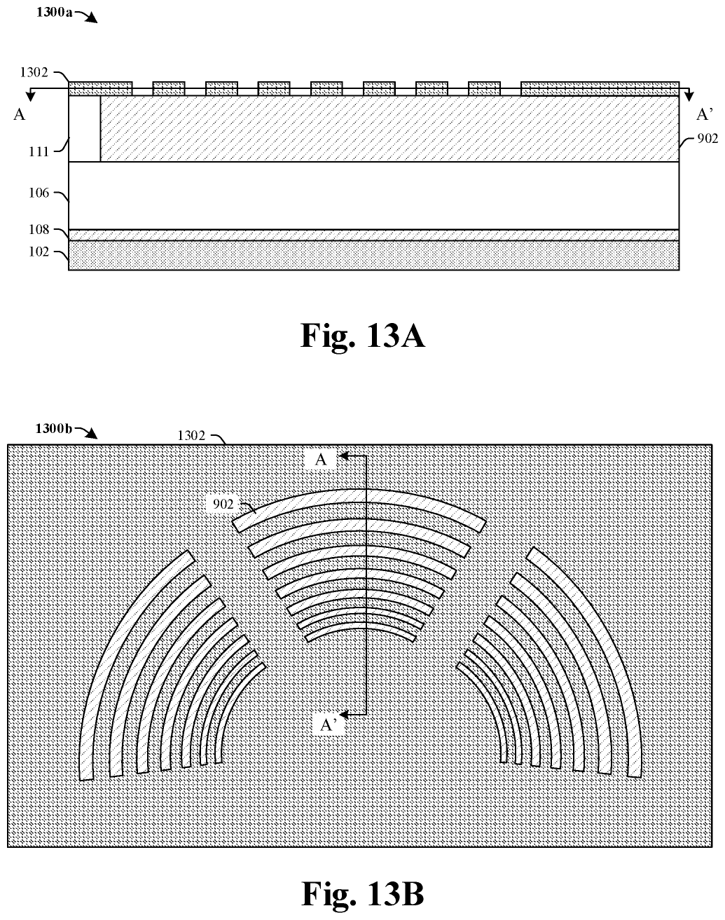

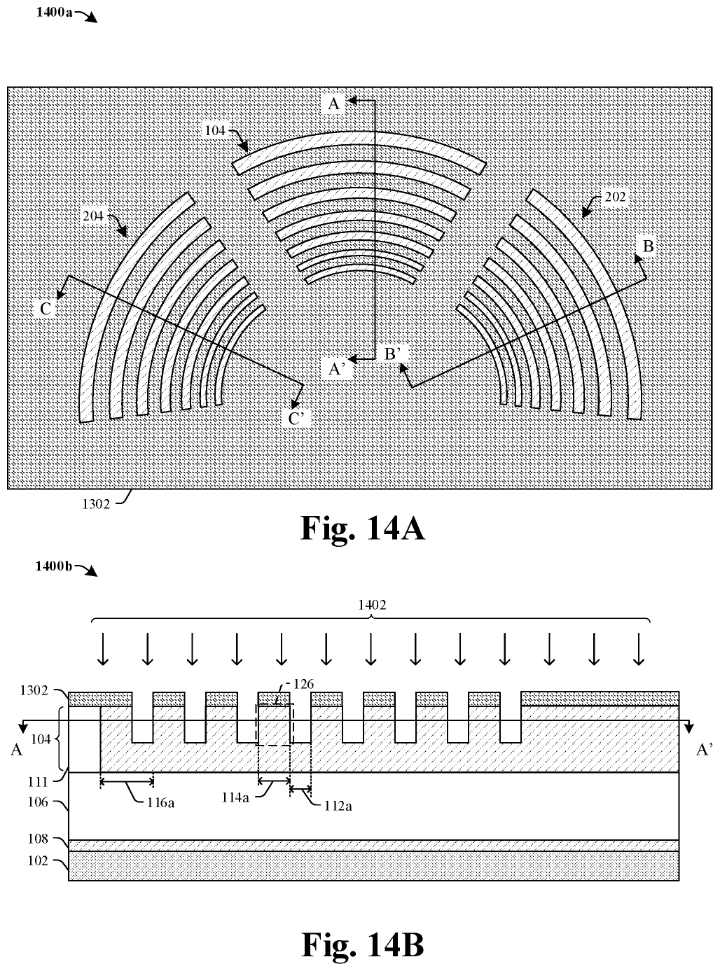

FIGS. 6A-6B, 7A-7B, 8A-8B, 9A-9B, 10A-10B, 11A-11B, 12A-12B, 13A-13B, 14A-14D, and 15A-15B illustrate cross-sectional views of some embodiments of a method of forming an optical module with a plurality of grating couplers and an optical combiner. Although FIGS. 6A-6B. 7A-7B, 8A-8B, 9A-9B, 10A-10B, 11A-11B, 12A-12B, 13A-13B, 14A-14D, and 15A-15B are described as a series of acts, it will be appreciated that these acts are not limiting in that the order of the acts can be altered in other embodiments, and the methods disclosed are also applicable to other structures. In other embodiments, some acts that are illustrated and/or described may be omitted in whole or in part.

As illustrated in the cross-sectional view 600a and top view 600b of FIGS. 6A and 6B, a substrate 102 is provided. In some embodiments, the substrate 102 is or comprises monocrystalline silicon, germanium, or the like. FIG. 6B illustrates the top view 600b of some embodiments of the optical module taken along line A-A′ of FIG. 6A.

As illustrated in the cross-sectional view 700a and top view 700b of FIGS. 7A and 7B, the mirror 108 is deposited over the substrate 102. In some embodiments, the mirror 108 is deposited by performing, for example, a physical vapor deposition (PVD) process, a chemical vapor deposition (CVD) process, an atomic layer deposition (ALD) process, or some other suitable deposition or growth process. In some embodiments, the mirror 108 is or comprises a metal such as gold, aluminum, or the like. The mirror 108 has a thickness approximately between 200 and 400 nanometers, approximately between 150 and 300 nanometers, approximately between 250 and 500 nanometers, or the like. FIG. 7B illustrates the top view 700b of some embodiments of the optical module taken along line A-A′ of FIG. 7A.

As illustrated in the cross-sectional view 800a and top view 800b of FIGS. 8A and 8B, the first dielectric 106 is deposited over the mirror 108. In some embodiments, the first dielectric 106 is formed by performing, for example, a PVD process, a CVD process, an ALD process, or some other suitable deposition or growth process. In some embodiments, the first dielectric 106 comprises silicon dioxide (SiO₂), a high-k dielectric, or the like. FIG. 8B illustrates the top view 800b of some embodiments of the optical module taken along line A-A′ of FIG. 8A.

As illustrated in the cross-sectional view 900a and top view 900b of FIGS. 9A and 9B, a first grating coupler precursor 902 is deposited over the first dielectric 106. In some embodiments, the first grating coupler precursor 902 is formed by performing, for example, a PVD process, a CVD process, an ALD process, or some other suitable deposition or growth process. In some embodiments, the first grating coupler precursor 902 is or comprises polysilicon, silicon nitride (Si₃N₄), or the like. FIG. 9B illustrates the top view 900b of some embodiments of the optical module taken along line A-A′ of FIG. 9A.

As illustrated in the cross-sectional view 1000a and top view 1000b of FIGS. 10A and 10B, a first masking layer 1002 is formed over the first grating coupler precursor 902. In some embodiments, the first masking layer 1002 is or comprises a photoresist patterned using photolithography. The first masking layer 1002 covers portions of the first grating coupler precursor 902 corresponding to the first plurality of grating couplers 201 (see FIG. 2A) and the optical combiner 205 (see FIG. 1A). FIG. 10B illustrates the top view 1000b of some embodiments of the optical module taken along line A-A′ of FIG. 10A.

As illustrated in the cross-sectional view 1100a and top view 1100b of FIGS. 11A and 11B, a first etch 1102 is performed on the first grating coupler precursor 902. In some embodiments, the first etch 1102 is a dry etch (e.g., a plasma enhanced dry etch). The first etch 1102 removes portions of the first grating coupler precursor 902 left exposed by the first masking layer 1002, resulting in a first opening 1104 over the first dielectric 106. FIG. 11B illustrates the top view 1100b of some embodiments of the optical module taken along line A-A′ of FIG. 11A.

As illustrated in the cross-sectional view 1200a and top view 1200b of FIGS. 12A and 12B, the first masking layer 1002 is removed. Additionally, the second dielectric 111 fills the first opening 1104 surrounding the first grating coupler precursor 902. In some embodiments, the first masking layer 1002 is removed using one or more stripping processes. In some embodiments, the second dielectric 111 is formed by performing, for example, a PVD process, a CVD process, an ALD process, or some other suitable deposition or growth process. A planarization process (e.g., a chemical mechanical planarization (CMP) process) is then performed, removing portions of the second dielectric 111 over a top surface of the first grating coupler precursor 902. FIG. 12B illustrates the top view 1200b of some embodiments of the optical module taken along line A-A′ of FIG. 12A.

As illustrated in the cross-sectional view 1300a and top view 1300b of FIGS. 13A and 13B, a second masking layer 1302 is formed over the first grating coupler precursor 902 and the second dielectric 111. In some embodiments, the second masking layer 1302 is or comprises a photoresist patterned using photolithography. The second masking layer 1302 covers portions of the first grating coupler precursor 902 corresponding to grating lines in the first plurality of grating couplers 201 (see FIG. 2A) and the optical combiner 205 (see FIG. 1A), leaving exposed portions of the first grating coupler precursor 902 between the grating lines of the first plurality of grating couplers 201 (see FIG. 2A) to be formed hereafter. FIG. 13B illustrates the top view 1300b of some embodiments of the optical module taken along line A-A′ of FIG. 13A.

As illustrated in the top view 1400a and cross-sectional views 1400b, 1400c, and 1400d of FIGS. 14A, 14B, 14C, and 14D, a second etch 1402 is performed on the first grating coupler precursor 902. In some embodiments, the second etch 1402 is a dry etch (e.g., a plasma enhanced dry etch). The second etch 1402 removes portions of the first grating coupler precursor 902 left exposed by the second masking layer 1302, exposing sidewalls of the grating lines of the first plurality of grating couplers 201 (see FIG. 2A). FIG. 14B illustrates the cross-sectional view 1400b of some embodiments of the optical module taken along line A-A′ of FIG. 14A. FIG. 14C illustrates the cross-sectional view 1400c of some embodiments of the optical module taken along line B-B′ of FIG. 14A. FIG. 14D illustrates the cross-sectional view 1400d of some embodiments of the optical module taken along line C-C′ of FIG. 14D.

As shown in FIGS. 14B-14D, the first grating coupler 104, the third grating coupler 202, and the fourth grating coupler 204 comprise grating lines 126 with the first, third, and fourth grating periods 116a, 116c. 116d (e.g., the distance between the start of a first grating line and the start of a subsequent grating line), the first, third, and fourth spacings 112a, 112c, 112d, (e.g., the distance between the end of the first grating line and the start of the subsequent grating line), and first, third, and fourth duty cycles 114a, 114c, 114d (e.g., the proportion of the grating period that is occupied by the first grating line). The first grating period 116a of the first grating coupler 104 is different from the third grating period 116c of the third grating coupler 202 and the fourth grating period 116d of the fourth grating coupler 204. Further, the first duty cycle 114a, the third duty cycle 114c, and the fourth duty cycle 114d are different from one another, and the first spacing 112a, the third spacing 112c, and the fourth spacing 112d are different from one another. The differences in the first grating period 116a, the third grating period 116c, and the fourth grating period 116d are one factor in the first grating coupler 104, the third grating coupler 202, and the fourth grating coupler 204 having bandwidths centered at different wavelengths. In some embodiments, the bandwidths of the third grating coupler 202 and the fourth grating coupler 204 overlap a first outer bandwidth limit and a second outer bandwidth limit of the bandwidth of the first grating coupler, respectively. That is, bandwidth of the third grating coupler 202 overlaps a first outer bandwidth limit of the first grating coupler 104, while the fourth grating coupler 204 overlaps a second outer bandwidth limit of the first grating coupler 104. The variation in the bandwidths of the first plurality of grating couplers, combined with their proximity, results in an optical module that is configured to receive electromagnetic input signals with a higher bandwidth than a conventional grating couplers, while maintaining a higher alignment tolerance.

As illustrated in the cross-sectional view 1500a and top view 1500b of FIGS. 15A and 15B, the second masking layer 1302 is removed. Additionally, the third dielectric 110 covers the first plurality of grating couplers 201. In some embodiments, the second masking layer 1302 is removed using one or more stripping processes. In some embodiments, the third dielectric 110 is formed by performing, for example, a PVD process, a CVD process, an atomic layer deposition ALD process, or some other suitable deposition or growth process.

FIG. 15B illustrates the top view 1500b of some embodiments of the optical module taken along line A-A′ of FIG. 15A. As shown in FIG. 15B, the steps shown in FIGS. 11A, 12A, 13A, 14A, and 15A results in the first plurality of grating couplers 201 comprising the first grating coupler 104, the third grating coupler 202, and the fourth grating coupler 204 being formed. The first grating coupler 104, the third grating coupler 202, and the fourth grating coupler 204 are coupled to the optical combiner 205 by the first waveguide 120, the third waveguide 222, and the fourth waveguide 224, respectively. The first grating coupler 104, the third grating coupler 202, and the fourth grating coupler 204 comprise grating lines 126 that are curved to guide input optical signals towards the first waveguide 120, the third waveguide 222, and the fourth waveguide 224 respectively. The first waveguide 120 branches off of the optical combiner 205 in a first direction towards the first grating coupler 104 and optically couples the first grating coupler 104 to the optical combiner 205. The third waveguide 222 branches off of the optical combiner 205 in a second direction towards the third grating coupler 202 and optically couples the third grating coupler 202 to the optical combiner 205. The fourth waveguide 224 branches off of the optical combiner 205 in third direction towards the fourth grating coupler 204 and optically couples the fourth grating coupler 204 to the optical combiner 205. In various embodiments, the first direction, the second direction, and the third direction are different from one another.

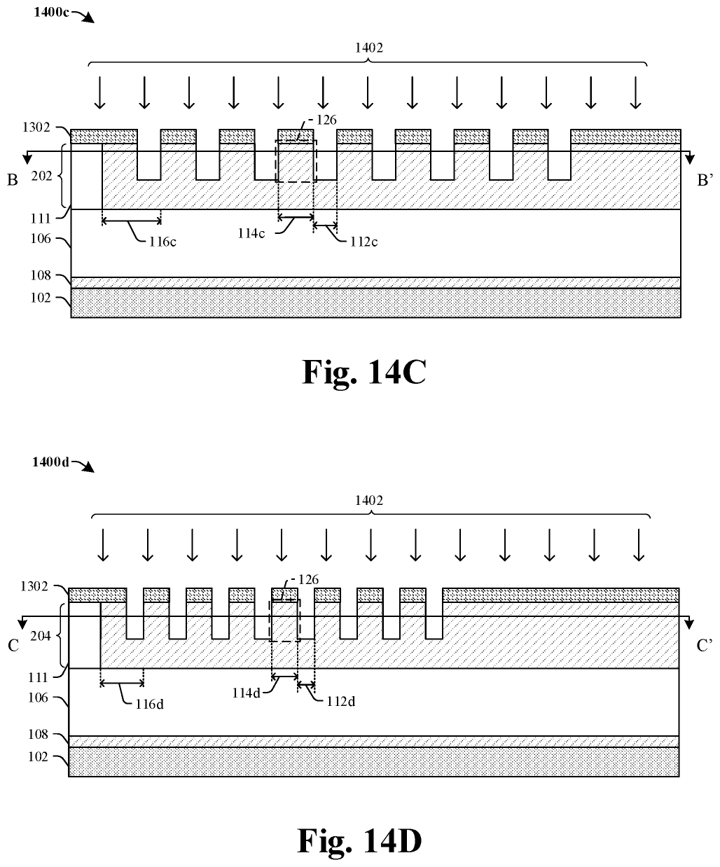

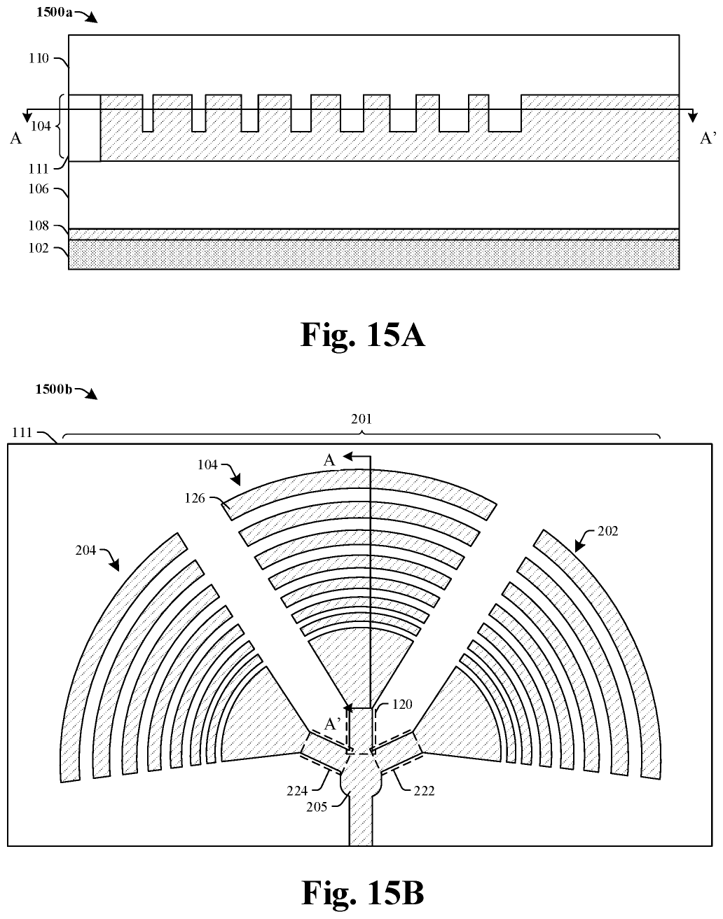

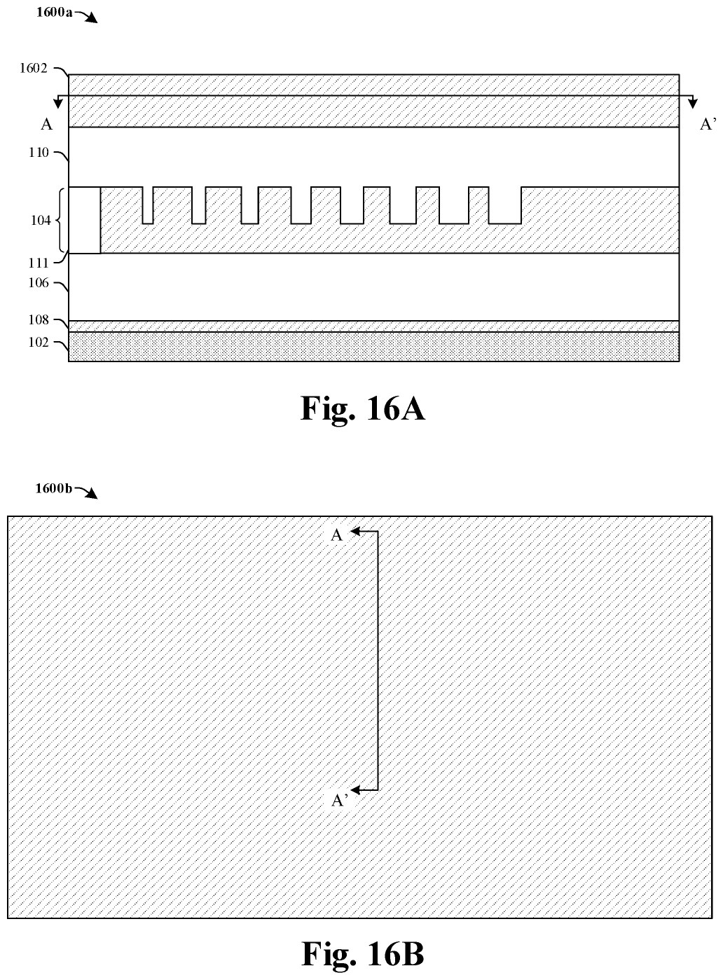

FIGS. 16A-16B, 17A-17B, 18A-18B, and 19A-19B, illustrate cross-sectional views of some embodiments of continuation of the method described in conjunction with FIGS. 6A-6B. 7A-7B, 8A-8B, 9A-9B, 10A-10B, 11A-11B, 12A-12B, 13A-13B, 14A-14B, and 15A-15B to form the second plurality of grating couplers 231 (see FIG. 2B). Although FIGS. 6A-6B, 7A-7B, 8A-8B, 9A-9B, 10A-10B, 11A-11B, 12A-12B, 13A-13B, 14A-14B, and 15A-15B are described as a series of acts, it will be appreciated that these acts are not limiting in that the order of the acts can be altered in other embodiments, and the methods disclosed are also applicable to other structures. In other embodiments, some acts that are illustrated and/or described may be omitted in whole or in part.

As illustrated in the cross-sectional view 1600a and top view 1600b of FIGS. 16A and 16B, the second grating coupler precursor 1602 is deposited over the third dielectric 110. In some embodiments, the second grating coupler precursor 1602 is formed by performing, for example, a PVD process, a CVD process, an ALD process, or some other suitable deposition or growth process. In some embodiments, the second grating coupler precursor 1602 is or comprises polysilicon, silicon nitride (Si₃N₄), or the like. FIG. 16B illustrates the top view 1600b of some embodiments of the optical module taken along line A-A′ of FIG. 16A.

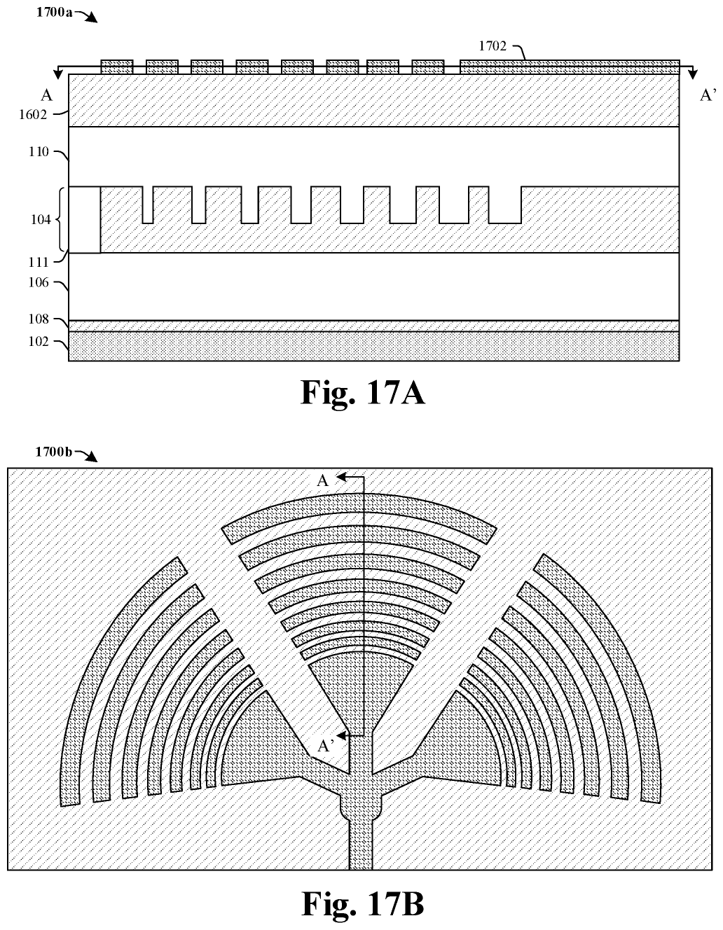

As illustrated in the cross-sectional view 1700a and top view 1700b of FIGS. 17A and 17B, a third masking layer 1702 is formed over the second grating coupler precursor 1602. In some embodiments, the third masking layer 1702 is or comprises a photoresist patterned using photolithography. The third masking layer 1702 covers portions of the second grating coupler precursor 1602 corresponding to grating lines in the second plurality of grating couplers 231 (see FIG. 2B) and the optical combiner 205 (see FIG. 1A). The third masking layer 1702 leaves exposed portions of the first grating coupler precursor 902 outside the second plurality of grating couplers 231 and between the grating lines of the second plurality of grating couplers 231 (see FIG. 2B). FIG. 17B illustrates the top view 1700b of some embodiments of the optical module taken along line A-A′ of FIG. 17A.

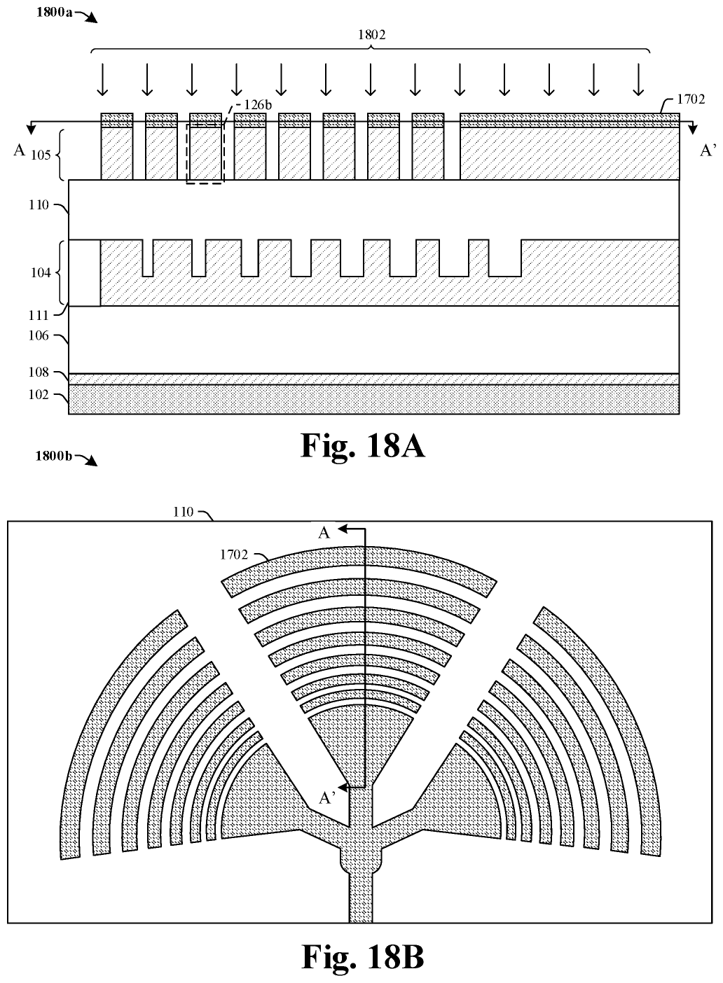

As illustrated in the cross-sectional view 1800a and top view 1800b of FIGS. 18A and 18B, a third etch 1802 is performed on the second grating coupler precursor 1602 (see FIG. 16A). The third etch 1802 removes portions of the second grating coupler precursor 1602 left exposed by the third masking layer 1702, resulting in the second plurality of grating couplers (see 231 of FIG. 2B) being formed. The second plurality of grating couplers (see 231 of FIG. 2B) have second grating lines 126b as described in relation to FIGS. 2A, 2B, 2C, and 2D. FIG. 18B illustrates the top view 1800b of some embodiments of the optical module taken along line A-A′ of FIG. 18A.

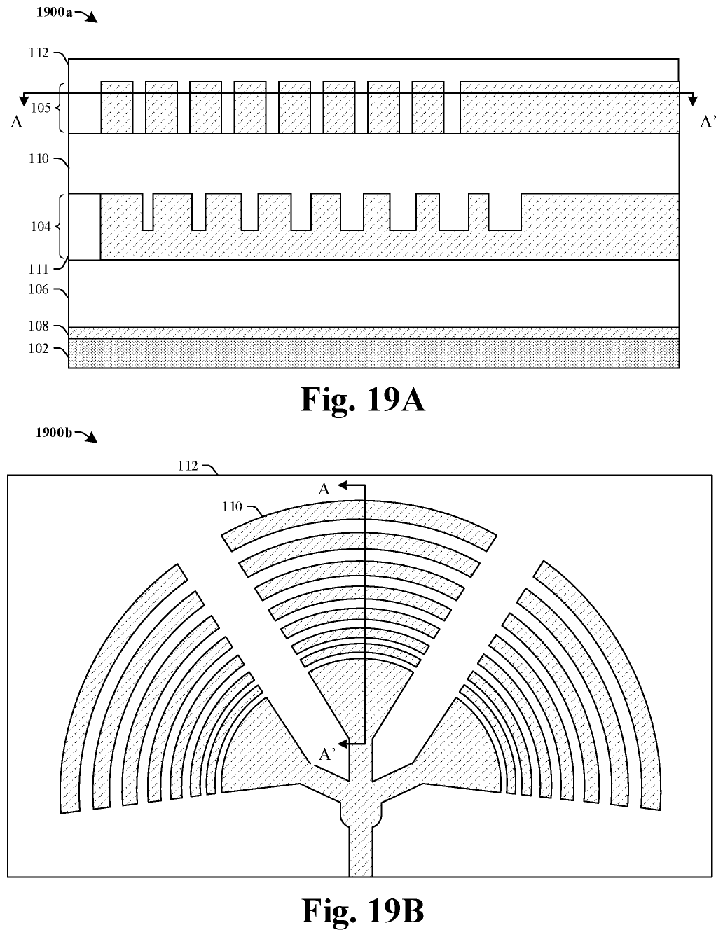

As illustrated in the cross-sectional view 1900a and top view 1900b of FIGS. 19A and 19B, the third masking layer 1702 is removed. Additionally, the fourth dielectric 112 is formed over and around the second plurality of grating couplers 231. In some embodiments, the third masking layer 1702 is removed using one or more stripping processes. In some embodiments, the fourth dielectric 112 is formed by performing, for example, a PVD process, a CVD process, an ALD process, or some other suitable deposition or growth process. FIG. 19B illustrates the top view 1900b of some embodiments of the optical module taken along line A-A′ of FIG. 19A.

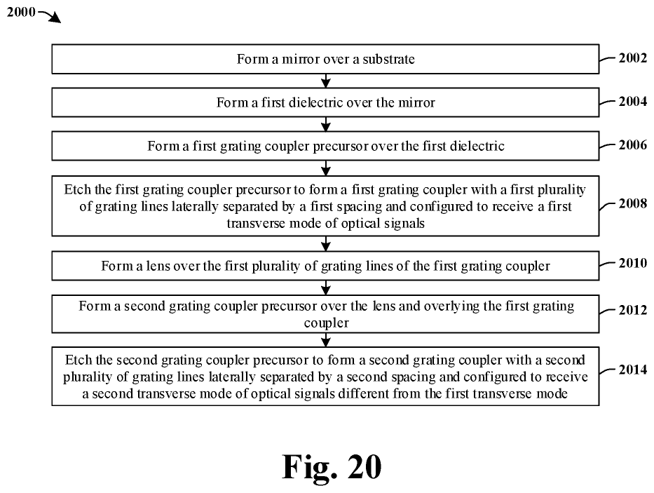

FIG. 20 illustrates a methodology 2000 of forming an optical module with a plurality of grating couplers and an optical combiner. Although this method and other methods illustrated and/or described herein are illustrated as a series of acts or events, it will be appreciated that the present disclosure is not limited to the illustrated ordering or acts. Thus, in some embodiments, the acts may be carried out in different orders than illustrated, and/or may be carried out concurrently. Further, in some embodiments, the illustrated acts or events may be subdivided into multiple acts or events, which may be carried out at separate times or concurrently with other acts or sub-acts. In some embodiments, some illustrated acts or events may be omitted, and other un-illustrated acts or events may be included.

At 2002, a mirror is formed over a substrate. See, for example, FIGS. 6A-6B.

At 2004, a first dielectric is formed over the mirror. See, for example, FIGS. 8A-8B.

At 2006, a first grating coupler precursor is formed over the first dielectric. See, for example, FIGS. 9A-9B.

At 2008, the first grating coupler precursor is etched to form a first grating coupler with a first plurality of grating lines laterally separated by a first spacing. See, for example, FIGS. 14A-14B.

At 2010, a lens is formed over the first plurality of grating lines of the first grating coupler. See, for example, FIG. 3D.

At 2012, a second grating coupler precursor is formed over the lens. See, for example, the lens shown in FIG. 3D and the second grating coupler precursor shown in FIGS. 16A and 16B.

At 2014, the second grating coupler precursor is etched to form a second grating coupler with a second plurality of grating lines laterally separated by a second spacing. See, for example, FIGS. 18A-18B.

Therefore, the present disclosure relates to a method of forming an optical module comprising a plurality of grating couplers and an optical combiner.

Some embodiments relate to an optical module including a substrate; a first grating coupler overlying the substrate; and a second grating coupler overlying the first grating coupler, where the second grating coupler is configured to receive a first transverse mode of an input optical signal while passing a second transverse mode of the input optical signal to the first grating coupler, and where the first grating coupler is configured to receive the second transverse mode of the input optical signal.

Other embodiments relate to an optical module, including a substrate; a first grating coupler overlying the substrate, wherein the first grating coupler includes a plurality of first grating lines laterally adjacent to a first tapered segment, where the plurality of first grating lines have a first grating period; and a second grating coupler overlying the substrate and adjacent to the first grating coupler, wherein the second grating coupler includes a plurality of second grating lines laterally adjacent to a second tapered segment, where the plurality of second grating lines have a second grating period different from the first grating period.

Yet other embodiments relate to a method of forming an optical module, including forming a first grating coupler precursor over a substrate; etching the first grating coupler precursor to form a first grating coupler with a first plurality of grating lines laterally separated by a first spacing; forming a first dielectric over the first grating coupler; forming a second grating coupler precursor overlying the first grating coupler; and etching the second grating coupler precursor to form a second grating coupler with a second plurality of grating lines laterally separated by a second spacing, wherein the second grating coupler is directly over the first grating coupler.

It will be appreciated that in this written description, as well as in the claims below, the terms “first”, “second”, “second”, “third” etc. are merely generic identifiers used for ease of description to distinguish between different elements of a figure or a series of figures. In and of themselves, these terms do not imply any temporal ordering or structural proximity for these elements, and are not intended to be descriptive of corresponding elements in different illustrated embodiments and/or un-illustrated embodiments. For example, “a first dielectric layer” described in connection with a first figure may not necessarily correspond to a “first dielectric layer” described in connection with another figure, and may not necessarily correspond to a “first dielectric layer” in an un-illustrated embodiment.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical module, comprising:
a substrate;
a first grating coupler overlying the substrate; and
a second grating coupler overlying the first grating coupler, wherein the second grating coupler is configured to receive a first transverse mode of an input optical signal while passing a second transverse mode of the input optical signal to the first grating coupler, and wherein the first grating coupler is configured to receive the second transverse mode of the input optical signal.

2. The optical module of claim 1, wherein the first grating coupler has a first bandwidth; and
wherein the second grating coupler has a second bandwidth substantially equal to the first bandwidth.

3. The optical module of claim 2, further comprising a third grating coupler level with and proximate to the first grating coupler and having a third bandwidth, wherein the third bandwidth partially overlaps a first outer wavelength limit of the first bandwidth.

4. The optical module of claim 3, further comprising:
an optical combiner coupled to the first grating coupler and the third grating coupler;
a first waveguide branching off the optical combiner in a first direction towards the first grating coupler, wherein the first grating coupler is optically coupled to the optical combiner by way of the first waveguide; and
a second waveguide branching off of the optical combiner in a second direction towards the third grating coupler, wherein the second direction is different from the first direction, and wherein the third grating coupler is optically coupled to the optical combiner by way of the second waveguide.

5. The optical module of claim 1, wherein the first transverse mode is a transverse electric (TE) mode and the second transverse mode is a transverse magnetic (TM) mode.

6. The optical module of claim 1, wherein the first grating coupler comprises first grating lines with a first spacing, and the second grating coupler comprises second grating lines with a second spacing different from the first spacing.

7. The optical module of claim 1, further comprising a lens between the first grating coupler and the second grating coupler.

8. The optical module of claim 1, further comprising a mirror beneath the first grating coupler configured to reflect the input optical signal back towards the first grating coupler and the second grating coupler.

9. The optical module of claim 1, wherein the first grating coupler has a first duty cycle that varies from a first end to a second end of the first grating coupler.

10. An optical module, comprising:
a substrate;
a first grating coupler overlying the substrate, wherein the first grating coupler comprises a plurality of first grating lines laterally adjacent to a first tapered segment, wherein the plurality of first grating lines have a first grating period; and
a second grating coupler overlying the substrate and adjacent to the first grating coupler, wherein the second grating coupler comprises a plurality of second grating lines laterally adjacent to a second tapered segment, wherein the plurality of second grating lines have a second grating period different from the first grating period, and wherein a distance between the first grating coupler and the second grating coupler is less than a length of the first grating coupler.

11. The optical module of claim 10, wherein the first grating coupler is spaced vertically between the second grating coupler and the substrate, wherein at least a portion of the plurality of second grating lines directly overlies at least a portion of the plurality of first grating lines.

12. The optical module of claim 10, further comprising:
an optical combiner overlying the substrate;
a first waveguide branching off the optical combiner in a first direction towards the first grating coupler, wherein the first grating coupler is optically coupled to the optical combiner by way of the first waveguide; and
a second waveguide branching off of the optical combiner in a second direction towards the second grating coupler, wherein the second direction is different from the first direction, and wherein the second grating coupler is optically coupled to the optical combiner by way of the second waveguide.

13. The optical module of claim 10, wherein the plurality of first grating lines have sidewalls that vary in height.

14. The optical module of claim 13, wherein the heights of the sidewalls of the plurality of first grating lines vary according to a Gaussian distribution.

15. A method of forming an optical module, comprising:
forming a first grating coupler precursor over a substrate;
etching the first grating coupler precursor to form a first grating coupler with a first plurality of grating lines laterally separated by a first spacing;
forming a first dielectric over the first grating coupler;
forming a second grating coupler precursor over the first dielectric; and
etching the second grating coupler precursor to form a second grating coupler with a second plurality of grating lines laterally separated by a second spacing, wherein the second grating coupler is directly over the first grating coupler.

16. The method of claim 15, wherein etching the first grating coupler precursor comprises:
performing a first etch to form a first optical combiner, a first waveguide coupled to the first optical combiner, and a second waveguide coupled to the first optical combiner; and
performing a second etching process to form the first plurality of grating lines of the first grating coupler, wherein the first grating coupler is coupled to the first waveguide, and to further form a third plurality of grating lines of a third grating coupler proximate to the first grating coupler, wherein the plurality of third grating lines are laterally separated from one another by a third spacing, wherein the third spacing is different from the first spacing and the second spacing, and wherein the third grating coupler is coupled to the second waveguide.

17. The method of claim 15, further comprising:
forming a mirror over the substrate before forming the first grating coupler precursor; and
forming a second dielectric before forming the first grating coupler precursor, the second dielectric spacing the mirror from the first grating coupler precursor.

18. The method of claim 15, further comprising:
forming a second dielectric before forming the second grating coupler precursor;
forming a lens before forming the second grating coupler precursor, wherein the lens is configured to redirect input optical signals towards the first grating coupler, and the second dielectric spaces the lens from the first grating coupler; and
forming a third dielectric before forming the second grating coupler precursor, the third dielectric overlying the lens.

19. The method of claim 15, wherein forming the first plurality of grating lines comprises a first etch that etches to a first depth within the first grating coupler precursor, resulting in a grating base beneath the first plurality of grating lines; and
wherein forming the second plurality of grating lines comprises a second etch that etches through a bottom surface of the second grating coupler precursor.

20. The method of claim 15, wherein the second spacing of the second grating coupler is configured to receive a first transverse mode of an input optical signal while passing a second transverse mode of the input optical signal to the first grating coupler, wherein the first spacing of the first grating coupler is configured to receive the second transverse mode of the input optical signal.
